(19) United States
(12) Patent Application Publication
(10) Pub. No.: US 2007/0024465 A1
(43) Pub. Date: Feb. 1, 2007

(54) Portable container with speaker attached

(76) Inventors: Thomas A. Howell, Palo Alto, CA (US); Angeline Hadiwidjaja, Los Altos, CA (US); Peter P. Tong, Mountain View, CA (US); C. Douglass Thomas, Campbell, CA (US)

Correspondence Address: IPVENTURE, INC., 5150 EL CAMINO REAL, SUITE A-22, LOS ALTOS, CA, 94022, US

(21) Appl. No.: 11/491,774

(22) Filed: Jul. 22, 2006

Related U.S. Application Data
(63) Continuation-in-part of application No. 11/314,545, filed on Dec. 20, 2005.
(60) Provisional application No. 60/636,969, filed on Dec. 20, 2004.
(60) Provisional application No. 60/652,213, filed on Feb. 14, 2005.
(60) Provisional application No. 60/670,957, filed on Apr. 13, 2005.
(60) Provisional application No. 60/689,312, filed on Jun. 10, 2005.
(60) Provisional application No. 60/732,925, filed on Nov. 2, 2005.
(60) Provisional application No. 60/732,925, filed on Nov. 2, 2005.
(60) Provisional application No. 60/785,825, filed on Mar. 24, 2006.

(51) Int. Cl. G08C 19/16

(52) U.S. Cl. 340/870.01

(57) ABSTRACT

In one embodiment, a portable container for a user including a container housing and a speaker attached to a portion of the housing. The area in the interior of the container at least adjacent to the speaker includes a compressible material. The housing is configured to carry a consumable substance. In one embodiment, the container further includes a memory device that is configured to store information that is related to the substance, and/or that is specific to the user. The speaker can output a message based on the information under a predetermined condition. Further, the speaker has a first surface and a second surface, with one of the surfaces directing at the interior of the container housing. Then as the speaker vibrates to generate sound waves, at least a portion of the sound waves from that surface of the speaker are directed towards the interior of the container housing, which improves the quality of the sound waves generated by the speaker and received by the user.

### CROSS-REFERENCE TO RELATED APPLICATIONS

This application is a continuation-in-part application of U.S. patent application Ser. No. 11/314,545, filed Dec. 20, 2005, and entitled “BOTTLE OF LOTION WITH A SENSOR,” which is hereby incorporated herein by reference, which claims priority to each of: (i) U.S. Provisional Patent Application No. 60/636,969, filed Dec. 20, 2004, entitled “PREVENTIVE MEDICAL SYSTEMS, METHODS AND APPARATUS,” and which is hereby incorporated herein by reference; (ii) U.S. Provisional Patent Application No. 60/652,213, filed Feb. 14, 2005, entitled “PREVENTIVE MEDICAL SYSTEMS, METHODS AND APPARATUS,” and which is hereby incorporated herein by reference; (iii) U.S. Provisional Patent Application No. 60/670,957, filed Apr. 13, 2005, entitled “BOTTLE OF LOTION WITH A LOTION SENSOR,” and which is hereby incorporated herein by reference; (iv) U.S. Provisional Patent Application No. 60/689,312, filed Jun. 10, 2005, entitled “PERSONAL AND PORTABLE BOTTLE,” and which is hereby incorporated herein by reference; and (v) U.S. Provisional Patent Application No. 60/732,925, filed Nov. 2, 2005, entitled “METHOD AND APPARATUS TO SENSE HYDRATION LEVEL OF A PERSON,” and which is hereby incorporated herein by reference.

This application also claims priority to: (i) U.S. Provisional Patent Application No. 60/732,925, filed Nov. 2, 2005, entitled “METHOD AND APPARATUS TO SENSE HYDRATION LEVEL OF A PERSON,” and which is hereby incorporated herein by reference; and (ii) U.S. Provisional Patent Application No. 60/785,825, filed Mar. 24, 2006, entitled “MEDICAL MONITORING SYSTEM,” and which is hereby incorporated herein by reference.

In addition, this application is related to: (i) U.S. patent application Ser. No. 11/314,545, filed Dec. 20, 2005, entitled “BOTTLE OF LOTION WITH A SENSOR,” and which is hereby incorporated herein by reference; (ii) U.S. patent application Ser. No. 11/451,781, filed Jun. 12, 2006, entitled “PERSONAL AND PORTABLE BOTTLE,” and which is hereby incorporated herein by reference; (iii) U.S. patent application Ser. No. 11/451,780, filed Jun. 12, 2006, entitled “HEALTHCARE BASE,” and which is hereby incorporated herein by reference; and (iv) U.S. patent application Ser. No. 11/479,665, filed Jun. 30, 2006, entitled “MOISTURE SENSOR FOR SKIN,” and which is hereby incorporated herein by reference.

### BACKGROUND OF THE INVENTION

For a very long time, people have been using portable containers, such as bottles and boxes, to carry different types of substances. For example, people have been taking pills, drinking water, and applying lotions from different types of bottles, taking cereal from different types of boxes, and carrying balls in canisters. Though people have been using containers all these years, the containers simply serve to carry substances.

It will be apparent from the foregoing that there is still a need for more intelligent portable containers.

### SUMMARY OF THE INVENTION

In one embodiment, a portable container for a user includes a container housing, a speaker and a memory device. The container housing is configured to carry a consumable substance, which the user can consume by accessing the substance from the container. The memory device is configured to carry information that is related to the substance, or that is specific to the user of the container. The speaker is attached to a portion of the container housing. The area in the interior of the container that is adjacent to the speaker includes a compressible material. Under a predetermined condition, the speaker outputs a message based on the information. The speaker has a first surface and a second surface. One surface of the speaker faces the interior of the container housing so that as the speaker vibrates to generate sound waves, at least a portion of the sound waves from that surface of the speaker moves towards the interior of the container housing. With such a configuration, the quality of the sound waves generated by the speaker and received by the user is improved.

In one embodiment, the speaker directly moves a compressible material to generate sound. As an example, the speaker is based on magnetic forces applied to a current carrying coil. To illustrate, the speaker includes the coil or a loop of wire, which is in a magnetic field. The loop is attached to the speaker membrane or diaphragm. Electrical signals in an alternating current are sent through the loop. Such a loop typically experiences a force in the magnetic field, and the force is transferred to the diaphragm. With an alternating current, the diaphragm is alternatively compressed and relaxed. Such vibrations are transferred to the compressible material, such as air, in the immediate neighborhood of the diaphragm, creating sound waves that follow the electrical signals. One way to change the volume and the pitch of the sound waves is by changing the strength and the frequency of the current. In one embodiment, the volume and/or the pitch of the sound waves that can be heard by a user of the container is referred to as the quality of the sound waves.

Typically, the speaker diaphragm has two surfaces. If there are compressible materials in the immediate neighborhood of both surfaces, and the compressible materials around both surfaces vibrate, both surfaces generate sound waves. However, the sound waves from both surfaces are out of phase. If sound waves from both surfaces are allowed to be combined, at least a portion of the combined sound waves would cancel each other, compromising the efficiency of the speaker, and reducing the quality of the sound waves generated. Typically, such reduction in quality is particularly obvious in the low frequency range because the wavelengths are relatively large.

In one embodiment, to improve the quality of the sound waves, the speaker is attached to a container, with one surface of the diaphragm facing the interior of the container. With at least the area in the interior of the container that is adjacent to the speaker filled with a compressible material, at least a portion of the sound wave generated by that surface is captured by the container and would not add destructively with the sound waves generated by the other surface of the speaker.

To illustrate, a speaker based on magnetic forces applied to a current carrying coil is attached to a portable container in a way that one surface of the speaker (or the diaphragm of the speaker) faces the interior of the container housing. Then as the speaker (or the diaphragm) vibrates to generate sound waves, at least a portion of the sound waves from that surface of the speaker (or the diaphragm) moves towards the compressible material in the interior of the container housing, and is captured by the interior of the container housing. As explained above, at least a portion the sound waves from that surface would not add destructively with the sound waves from the other surface of the speaker (or the diaphragm). With such a configuration, the quality of the sound waves generated by the speaker and received by the user is improved.

One embodiment removes at least a portion of the container wall where the speaker (or the diaphragm of the speaker) is attached. With the portion removed, one surface of the speaker (or the diaphragm) could be in direct contact with the compressible material inside the container at least in the area adjacent to the speaker.

Another embodiment has a membrane or a layer of material between the interior of the container and the speaker (or its diaphragm) where the speaker is attached. As the speaker vibrates to generate sound waves, the membrane follows the vibrations. In yet another embodiment, instead of having an extra membrane, the speaker is attached over the container, and the container wall, at least in the area of attachment, is relatively thin. As the speaker vibrates to generate sound waves, at least the area on the container where the speaker is attached also vibrates. In both embodiments, the vibrations of the membrane and at least a portion of the container wall are translated to the compressible material in the interior of the container adjacent to the speaker.

In another embodiment, a speaker is directly attached to the container, and the speaker moves at least a portion of the wall of the container to generate sound. One example of such a speaker is a piezoelectric speaker that uses a piezoelectric element to convert electrical signals to sound waves. In one embodiment, the speaker has two surfaces. For example, one surface can be the surface of a metal diaphragm or film, which is pasted or connected to one side of the piece of piezoelectric element. The other side of the piece of piezoelectric element has an electrode and forms the other surface. Electrical signals in the form of alternating voltages can be applied between the metal diaphragm and the electrode across both sides of the piece of piezoelectric element. The signals deform the element, which in turn vibrates the diaphragm.

With the piezoelectric speaker attached to the container wall, one surface of the piezoelectric speaker faces the interior of the container housing. As the piezoelectric speaker vibrates, at least a portion of wall follows the vibration to generate sound waves. This can increase the area of the vibration surface from just the piezoelectric speaker to generate sound. As the container wall vibrates, the surface facing the interior of the container generates sound waves at least in the compressible material adjacent to the speaker. At least a portion of the sound waves generated moves towards the interior of the container housing, and is captured by the container housing. As explained above, at least a portion the sound waves from that surface would not add destructively with the sound waves from the surface of the container wall facing away from the interior of the container. With such a configuration, the quality of the sound waves generated by the piezoelectric speaker and received by the user is improved.

In yet another embodiment, at least one surface of the piezoelectric speaker is curved. In one embodiment, both surfaces of the speaker are curved, with one being concave and the other being convex. The concave surface can be the surface facing the interior of the container. The convex surface can be the surface where at least a substantial amount of the sound waves generated propagate away from the container.

In one embodiment, there are more than one speaker attached to a portable container. The multiple speakers can be different types of speakers. For example, there are two speakers attached to a container, with one being a piezoelectric speaker and the other being a speaker based on magnetic forces applied to a current-carrying wire.

In another embodiment, a portable container also includes a memory device that is configured to carry information to generate messages. The messages can be related to the consumable substance designed to be carried by the container, and/or specific to the user of the container. A speaker attached to the housing can output the messages under one or more predetermined conditions.

A number of embodiments of the invention use a portable bottle or an intelligent bottle as an example of a portable container to illustrate different features of the invention. The intelligent bottle is typically portable. The intelligent bottle can also be personal to its user. The intelligent bottle can be implemented in various ways and with various features or aspects.

In one embodiment, the present invention provides a personal and portable bottle with a thermometer integral with or electrically coupled to the bottle, and with the bottle carrying medication for fever (antipyretic), such as acetaminophen.

In one embodiment, the bottle can include one or more electrical attributes. For example, the bottle can include an output device, such as a display, a speaker and/or a tactile output device. The bottle can include an input device, such as one or more input buttons, a key pad, a stylus with pull down menu on a screen, a microphone, and/or a digital camera.

In one embodiment, the bottle can be connected to another electrical device, such as a memory device or a computer. This can be done physically such as through an electrical connector at the bottle. In another embodiment, the connection can be achieved wirelessly. For example, the bottle can include wireless communication capabilities, such as a RFID tag; electronics for global positioning; short distance communication electronics such as for Bluetooth, WiFi and infrared; and longer distance communication electronics such as for WiMax or cellular networks, which can be special-purpose phone to specific destinations. The connection can facilitate data exchange. For example, based on the connection, information in the bottle can be transferred to another device. This allows, for example, a user to transfer information from one bottle to another bottle.

In one embodiment, a bottle can be battery-powered. The bottle can have power conservation capabilities. For example, the bottle can be in sleep-mode until there is motion in the immediate vicinity of the bottle, or until the bottle is moved.

In another embodiment, a bottle can include browsed/search capabilities to allow information in the bottle to be electronically browsed/searched.

A bottle can have a number of physical attributes. For example, the bottle can include more than one compartment. One or more of the compartments can be detached. For example, the compartment(s) holding the electronics or the substances in the bottle can be detached. The user can detach the one or more compartments before washing the bottle. There can also be more than one compartment to hold additional substances.

In one embodiment, a bottle includes one or more electrical components, which can also be detached. For example, one electrical component is a memory card, which can be detached. Information to be stored by, for or in the bottle can be stored in the memory card.

Based on the one or more physical and/or electrical attributes, a bottle can keep track of personal information regarding the user, such as the user's health data. For example, the bottle can keep track of the temperatures or blood pressures of the user. The bottle can keep track of how often and how much the user has been taking the substance in the bottle. Other personal information can include the identity of the user. The bottle can track inputs entered into the bottle by the user. Inputs can be provided by the user through responding to questions from the bottle. The user can also download information from a device to the bottle. Information regarding the user can also be provided by others, such as a supplier of the bottle with the substance inside. The supplier can be the seller (e.g. drug company) or dispenser (e.g. pharmacist or drug store) of the bottle, or a medical personnel (e.g. doctor). For example, a pharmacist can download information regarding the user to the bottle when the pharmacist provides medications to the user.

In one embodiment, a bottle can keep track of additional information. For example, the bottle can keep track of information from a seller or a dispenser of the bottle. This can be specific information on the medication carried by the bottle, or products/services related to the medication. Such information can be downloaded into the bottle, such as by the seller or dispenser. The bottle can also keep track of conditions regarding the environment (e.g. surroundings) of the bottle, such as temperature. In one embodiment, information regarding the environment can be used to dynamically determine whether the content (e.g. medicine) of the bottle is still suitable for use. The environment can also influence how often its content is to be used.

In one embodiment, based on information available from a bottle, the bottle can perform one or more applications for the user. There are many exemplary applications. For example, the bottle can provide information and/or recommendations to the user. The bottle can call out the name of the user when it is activated. The bottle can tell the user what the time is. The bottle can educate the user regarding its content. The bottle can remind the user when the time comes to take the content and how much the user should be taking. The bottle can alert the user on health issues regarding the user, such as the user should be going for a checkup, or the user has vital health problems and should go see a doctor immediately. In one embodiment, the bottle allows the user to record voice messages, which can be time-stamped. The messages can also be linked to measurements made by the sensor, such as the thermometer.

Regarding buying products, in one embodiment, a bottle can alert the user on replenishing the substance inside the bottle. The bottle can also provide other options regarding medication to acquire based on the user's characteristics.

Regarding promoting products/services to the user, in one embodiment, a bottle can show advertisement. The source of the advertisements can be from the seller when the bottle was acquired, or downloaded from a website at a subsequent time. The advertisement can be interactive. For example, there can be embedded hyperlinks and/or pop-up windows in the advertisements.

Based on the information stored or acquired, the bottle can provide one or more applications for others. In one embodiment, based on measurements regarding the user, the bottle can alert one or more people interested in the well being of the user. They can include the user's relative, or the health care provider the user previously registered with. In another embodiment, the interested person can wirelessly access information in the bottle, such as through a cellular connection.

In one embodiment, specific information can be sent every time when the user takes a measurement or takes the substance in a bottle. Alternatively, the information can be sent only when there are some critical issues, for example, the user's temperature exceeding a certain threshold. In yet another embodiment, specific information is sent when requested by the user, such as when the user pushes a button on the bottle. Information can also be sent on request from a remote interested user.

The information kept in a bottle can be for subsequent use. In one embodiment, a doctor can download the information later. Such download can be done remotely, such as through a website, or locally, such as when the user is in the doctor's clinic.

The bottle can provide information to its seller. In one embodiment, a bottle carrying a substance can keep track of its own location, such as from its manufacturer to the pharmacy carrying it. Such location information can be periodically sent to its seller, and can help, for example, to ensure the medication produced is the medication given out to the patients, or reduce the problems of losing medication or not having sufficient supplies at hand.

In one embodiment, a bottle can alert the seller regarding its content, such as when its content is getting low. The bottle can keep track of whether its promotional materials has been read, such as whether its pop-up windows have been acknowledged or clicked. The seller can receive such information through the bottle's electrical connection, such as physically through the bottle's electrical connector, or wirelessly.

The information collected by a bottle can be personal and can be confidential. In one embodiment, the information in the bottle can be accessed only by the user. In another embodiment, whenever there is access, the user will be notified. The information can also be password protected and/or encrypted.

In one embodiment, one or more other types of sensors applicable to measure the user can be integral with or coupled to a bottle. One example of a sensor is a thermometer, as noted above. Another example of a sensor is a skin hydration sensor or a lotion sensor. In such case, the bottle can be a bottle of lotion.

In another embodiment, a sensor can be a secretion sensor based on reagent, such as a flu sensor, with a bottle carrying antipyretic/analgesics such as acetaminophen or ibuprofen. In one embodiment, the secretion sensor includes a sensor head and a sensor tube. The sensor head can include a printed circuit board and is adapted for repeated usage. The sensor tube includes reagents on absorptive material (e.g. filter paper) in the shape of a tube, and can be disposable. The sensor head can include multiple pairs of LED and photodiode, and the sensor tube can include multiple reagents. Each pair of LED and photodiode is adapted to measure one reagent. There can be one extra pair of LED and photodiode serving as an identifier to determine which types of reagents are on the sensor tube.

In one embodiment, a sensor can be a saliva sensor, with a bottle carrying a type of beverages. The saliva sensor can measure the viscosity of the saliva, which can then tell the hydration level of the user, or how well hydrated the user is.

In one embodiment, information from more than one sensor can be used to provide personal information regarding the user. For example, there can be an activity sensor, such as a pedometer, to keep track of the user's activity. Such activity information can be used with information from a saliva sensor to provide guidance to the user on fluid intake. As another example, another sensor can be a temperature sensor to measure, such as the environment temperature.

The substance in the bottle can pertain to medication, whether prescribed by medical personnel, or over-the-counter medication. In one embodiment, a bottle carries antidepressant medication, such as Paroxetine or Fluoxetine. Every day, the user activates a bottle and answers a number of questions from the bottle. The questions can be related to the user's mood, sleep pattern and activity level. The user's answers are summarized, such as charted or graphed, and presented to the user's healthcare provider. Based on the data presented, the provider adjusts the medication dosage for the user.

In another embodiment, a bottle carries antihypertensive drugs. Both over and under dosage of such drugs can be dangerous. Every day, the user activates the bottle and measures his blood pressure. Based on the measurement and the user's responses to a number of questions, the bottle could send the data to healthcare professionals. The data are typically summarized, charted and/or graphed before sending to the healthcare professionals. This can enable real-time titration/adjustment of drug dosage, thus enabling quick stabilization of the user's hypertension.

In one embodiment, a user has asthma, and a bottle has medications and monitoring sensor for asthma. The bottle can have a peak flow meter and one/two metered dose inhaler such as bronchodilator, like Albuterol, and inhaled steroid, like Fluticasone. Based on the measurement of the peak flow meter, and answers to a number of questions on additional symptoms, the bottle could recommend the dose (number of puffs)/frequency of metered dose inhaler. The recommendation may depend on the user severity of asthma, as previously determined by healthcare professional. The metered dose inhaler can also be set automatically to adjust its dosage, and recommends the user on the frequency and the number of puffs each day, based on the peak flow reading and asthma severity.

In one embodiment, a user has attention deficit hyperactivity disorder. On a daily basis, the user's parents activate a bottle and answer a number of questions regarding the user, such as the user's attention and hyperactivity scales. Within a time period, such as one week, the bottle can produce a set of data that can be summarized and charted, which can be sent to the user's health care professionals for adjustment of medication dose. This data can also be useful to encourage/motivate user to take medication. The bottle can also include a built-in safety mechanism. If the bottle suspects over-dosage abuse, the bottle can alert a healthcare provider.

In another embodiment, a bottle monitors other types of information that can be personal to the user. For example, there can be different ways to monitor the usage of the substance in a bottle. One way to monitor usage is by weight measurements. In one embodiment, a sensor can sense each time the bottle is opened. In another embodiment, a sensor can measure the empty space, or the distance or the volume between the opening of the bottle and the top level of the content in the bottle.

There can also be other types of user inputs requested by the bottle. In one embodiment, the bottle can monitor the user's mental capacity. This can be done, for example, by asking the user to answer a set of questions. Information regarding the user's prior health history can also be provided by the user to the bottle.

In one embodiment, information regarding the user can also be provided by other instruments. These instruments can be wirelessly coupled to a bottle, such as through Bluetooth, WiFi or infrared. Examples of such instruments include a scale for the weight of the user.

Other information regarding the bottle's environment can be monitored by a bottle. For example, the bottle can keep track of the humidity of its immediate vicinity through a humidity sensor at or coupled to the bottle.

The bottle can also perform other functions. In one embodiment, a bottle can provide other personalized educational materials related to its content to the user. To illustrate, the bottle can hold diabetes medication, such as insulin. The bottle can educate the user issues regarding foot problems because many people with diabetes develop foot problems also.

In one embodiment, a bottle can guide a user through a program. For example, the bottle can track the user's progress and compare it to the user's weight-loss goals.

In one embodiment, a number of applications described above can be performed by a computer or a website, instead of the corresponding bottle.

A number of embodiments have been described regarding a portable bottle. In other embodiments, instead of a portable bottle, different features described for a portable bottle are applicable to a portable container.

Other aspects and advantages of the present invention will become apparent from the following detailed description, which, when taken in conjunction with the accompanying drawings, illustrates by way of example the principles of the invention.

### BRIEF DESCRIPTION OF THE DRAWINGS

FIG. 1 shows a bottle with a thermometer according to one embodiment of the invention.

FIG. 2 shows examples of a bottle's electrical attributes according to different embodiments of the invention.

FIG. 3 shows examples of a bottle's wireless connections according to different embodiments of the invention.

FIG. 4A shows examples of a bottle's physical attributes according to different embodiments of the invention.

FIG. 4B shows a bottle with two compartments and a thermometer according to one embodiment of the invention.

FIGS. 5A-5B show examples of the sources of the personal information in a bottle according to different embodiments of the invention.

FIG. 6 shows examples of other types of information in a bottle according to different embodiments of the invention.

FIG. 7 shows examples of different applications by a bottle according to different embodiments of the invention.

FIGS. 8A-8B show processes performed by a bottle regarding the use of the substance in the bottle according to different embodiments of the invention.

FIG. 9 shows examples of different attributes on information security regarding a bottle according to different embodiments of the invention.

FIG. 10 shows examples of at least a portion of the functions previously described as performed by a bottle being performed by another device, according to different embodiments of the invention.

FIG. 11 shows an embodiment of a base for a bottle according to one embodiment of the invention.

FIGS. 12A-12E show examples of other types of thermometers according to different embodiments of the invention.

FIG. 13 shows examples of other types of sensors to provide different types of health information regarding the user according to different embodiments.

FIGS. 14A-14C show examples of reagent sensors sensing a secretion according to different embodiments of the invention.

FIGS. 15A-15C show a saliva sensor that can continually sense certain attributes in saliva according to different embodiments of the invention.

FIGS. 16A-16D show examples of different applications of the present invention for prescription drugs according to different embodiments of the invention.

FIG. 17 shows examples of motivations provided to a user according to different embodiments of the invention.

FIG. 18 shows an embodiment of a portable bottle with a sensor coupled to the bottle housing according to the present invention.

FIGS. 19A-B show an embodiment of a portable bottle having a speaker attached, with the speaker having a current-carrying wire in a magnetic field, according to the present invention.

FIG. 20 shows an embodiment of a portable bottle with a piezoelectric speaker attached according to the present invention.

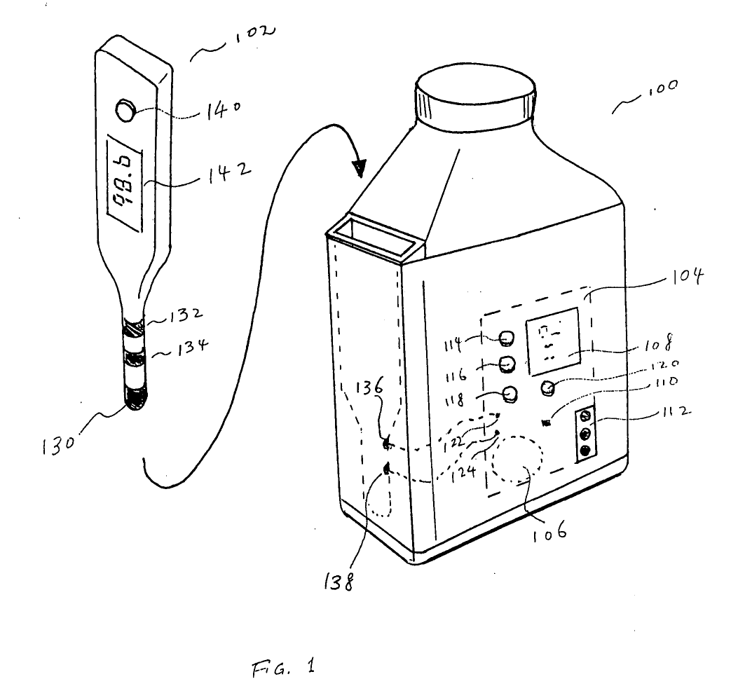

Same numerals in FIGS. 1-20 are assigned to similar elements in all the figures. Embodiments of the invention are discussed below with reference to FIGS. 1-20. However, those skilled in the art will readily appreciate that the detailed description given herein with respect to these figures is for explanatory purposes as the invention extends beyond these limited embodiments.

### DETAILED DESCRIPTION OF THE INVENTION

FIG. 1 shows a portable bottle 100 with a thermometer 102 according to one embodiment. The bottle 100 can keep personal information of a user, and the information can be from a sensor integral with or coupled to the bottle 100. In this embodiment, the sensor is a thermometer 102 that can measure the temperatures of the user, and the bottle 100 can carry Acetaminophen pills.

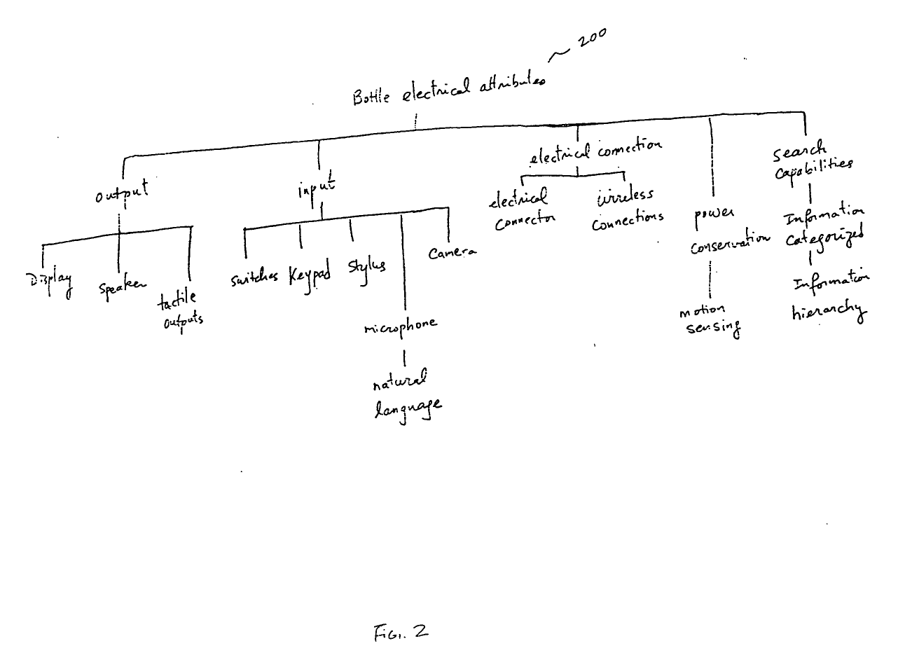

FIG. 2 shows examples of a bottle's electrical attributes 200 according to different embodiments. The bottle can have one or more output mechanisms. For example, the bottle can have a display. The display can be a liquid crystal display. In one embodiment, the display is an electrophoretic display. The bottle can have a speaker to provide audio outputs. The audio signals can be a song, or a part of a song, such as a ring tone. In another embodiment, the output is a form of tactile output, or the output can depend on vibrations.

In one embodiment, the bottle can have one or more input mechanisms. The bottle can have one or more input buttons or switches, a keypad and/or stylus to allow inputs by hand. There can be a pull-down menu on a display on the bottle. The stylus can activate the pull-down menu to enter information into the bottle. The inputs can be through voice. There can be a microphone on the bottle to receive voice signals by the user. The bottle can understand natural language by the user. There are different approaches to implement such natural-language comprehension, as discussed, for example, in U.S. Pat. No. 6,498,921, entitled, “Method and system to answer a natural-language question”, which is hereby incorporated by reference into this application. In yet another embodiment, the input mechanism is visual. The bottle can include a camera to take pictures as entry.

In one embodiment, the bottle includes one or more electrical connection mechanisms to couple the bottle to one or more electrical devices. One such electrical connection mechanism is an electrical connector, which can be used to plug the bottle to a physical network. For example, the bottle can have a standard electrical connector, such as a USB connector. As another example, the bottle has a non-standard electrical connector. Such connector can connect the bottle to another electrical device, such as a memory device, like a flash card, or connect the bottle to a computer.

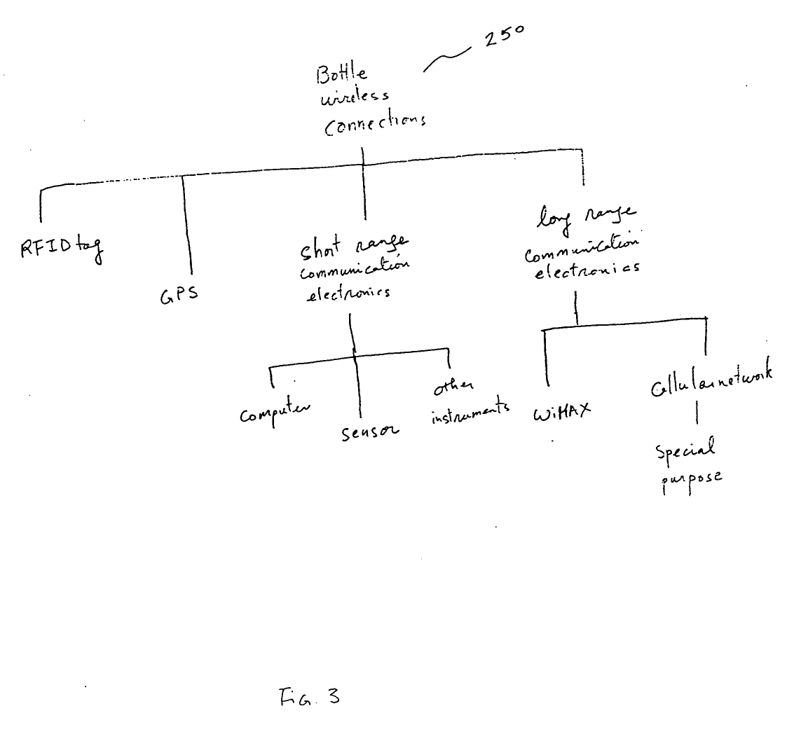

In one embodiment, the bottle can include electronic circuits to allow the bottle to be coupled to a wireless network. FIG. 3 shows examples of a bottle's wireless connections 250 according to different embodiments. For example, the bottle has a RFID tag to allow the bottle to be coupled to a RFID network. RFID tags typically include memory chips equipped with radio antennas. Typically, the memory chips do not include tremendous amount of information. They may only have 2 kilobytes, sufficient to encode, such as a serial number, where and when a product was manufactured, and other relevant information. These tags can come in a number of configurations. For example, an active tag uses a battery-powered transponder to emit a constant signal carrying the identifying information programmed into the chip. Active tags are more applicable to situations where readers are not close to the tags. A semi-passive tag likewise has a battery, but may not be activated until it receives a signal from a reader. They are more applicable to situations that do not need continuous connection and accessing. A passive tag has no battery; its antenna extracts power from the reader's radio wave signal to transmit the identifying information on the chip. Passive tags are typically relatively inexpensive, but may have to be within a few feet of a reader to extract power.

In another embodiment, the bottle includes a position-sensing device, which can be based on GPS technologies, to couple to position-sensing information. For example, the device can wirelessly acquire position signals, extract raw position data from the signals, and convert the raw position data into the position of the position-sensing device.

In one embodiment, the bottle includes electronics for short-range communications, such as those based on Bluetooth, UWB, Zigbee, WiFi, infrared or other types of short-distance wireless transmission standards. For example, the bottle can include a short-range analog or digital wireless transceiver under one of the standards. Based on the short-range communication electronics, the bottle can wirelessly connect to another computing device, another sensing device and/or another instrument.

In another embodiment, the bottle includes electronics for long-range or longer-range communications, such as those based on WiMax or cell-phone standards. For example, the bottle can include a special purpose one-way phone that is only connected to one or more specific destinations. For example, instead of dialing all the numbers of the destination(s), a person only needs to push one button on the bottle, and the bottle will be connected to the destination(s). One such location can be the cell phone number of a healthcare provider of the user. Another can be a SMS message to an electronic address of a relative of the user. Yet another can be to a 911 operator.

Based on one or more electrical connections, information in a bottle can be transferred to another device, or bottle. For example, information in a bottle can be downloaded to a storage medium. In another example, information in a bottle can be transferred to another bottle.

In one embodiment, a bottle can be battery powered. The battery can be re-chargeable. In another example, the battery is not designed to be replaceable by the user. In another embodiment, a bottle includes power conservation algorithm. For example, the bottle goes into a sleep mode if its electronics are not activated or if there is no input into the bottle for more than a pre-set period of time, such as fifteen minutes. In another example, to conserver power, the display on the bottle is turned on only if a motion sensor in the bottle senses motion in the immediate vicinity of the bottle, or if the bottle has been moved.

In another embodiment, the bottle includes browse/search capabilities to allow information in the bottle to be browsed/searched and accessed. For example, different pieces of information stored in an electronic storage device in a bottle can be categorized, and the categorization can be hierarchical, with multiple levels in the hierarchy. To illustrate, assume that there are two levels. The top level can be the name of a medication, and the second level can be the time a specific medication was taken. The entries, such as the name of a medication, can be abbreviated. There can be a control knob or switch to allow the user to scroll down entries in a level. By pushing the knob, the user selects an entry, which can lead the user to the next level. There can be an entry for moving up a level also. In one embodiment, once an entry is selected, the identity of that entry will be announced. For example, a selected entry is about acetaminophen or Aspirin. Once that entry is selected, a speaker in the bottle will announce, “Aspirin.” If that is the one the user wants, the user can signal his preference by, for example, pushing a switch in the bottle. Another example of information access is through, for example, pull-down menus, as discussed, for example, in U.S. Pat. No. 6,839,699, “Natural query interface based on concept selection,” which is hereby incorporated by reference.

In the example shown in FIG. 1, a plurality of the bottle's electrical components can be on a printed circuit board 104. To clarify the description, the figure only shows some of the components, such as a printed circuit board 104 with four input buttons, a battery 106, a LCD display 108, a microcontroller unit 110 and an output port 112 with three connecting contacts. The four input buttons 114, 116, 118 and 120, can be for up, down, back and enter (or select) respectively. The up button 114 can be used to move a cursor on the display 108 up, the down button 116 move the cursor down, the back button 118 allow the user to go back to the previous entry, and the enter button 120 allow the user to select an entry.

In one embodiment, any of the buttons can serve as an on switch for the bottle. If any of the buttons is pushed, the bottle will be activated. If no buttons are pushed, or no entries are made for a duration of time, such as 10 minutes, the bottle will deactivate. In another embodiment, after activation, the display 108 can show an exit icon, which, if entered, will turn off the bottle.

The three contacts of the output port 112 can be for Tx, Rx and Gnd connections respectively. In another embodiment, the output port can be a standard connector, like a telephone plug.

In the example shown in FIG. 1, the printed circuit board 104 also includes two electrical connecting points 122 and 124 to receive two leads from signals from the sensor 102. In one embodiment, the temperature sensor 102 includes a heat sensor 130, such as a thermocouple, located at the tip of the temperature sensor 102. The temperature sensor 102 also includes two conductors, 132 and 134, configured to connect to two conductors, 136 and 138, at the bottle 100 (for example, when the sensor 102 is placed into a slot or opening of the bottle, such as shown in FIG. 1) to upload information, such as temperature information, from the sensor 102 to the bottle 100. Instead of physical connections, in one embodiment, the connections between the bottle 100 and the temperature sensor 102 can be wireless connections.

The temperature sensor 102 also can include an on/off switch 140 and a display 142, such as a LCD display, to show temperatures measured.

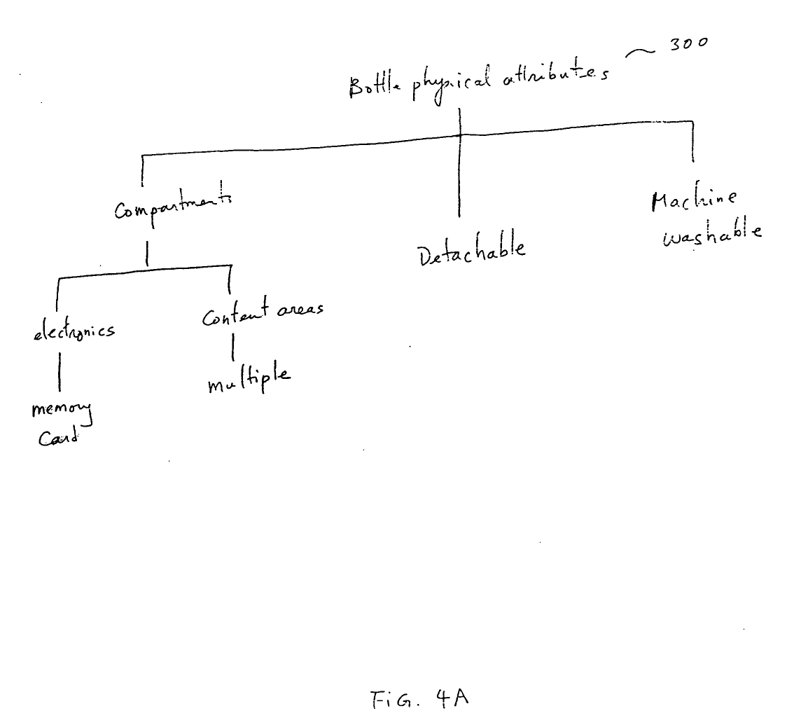

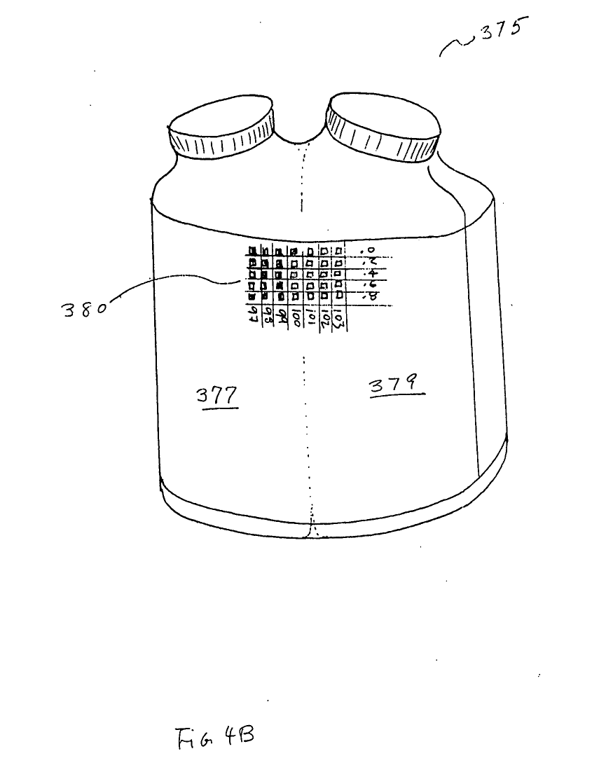

FIG. 4A shows examples of a bottle's physical attributes 300 according to different embodiments. In one embodiment, the bottle includes multiple compartments. One compartment can be for all or most of the electrical components in the bottle. In one embodiment, the electrical components can include a memory card or a memory stick that is removable. Information can be stored in the memory card.

There can be multiple areas to store multiple substances. For example, FIG. 4B shows a bottle 375 with two compartments, 377 and 379, and a thermometer 380. The thermometer 380 can be implemented by a thermochromic paint, which can be insulated from the bottle 375 by a piece of thermally insulating material between the bottle 375 and the paint 380. This will prevent the paint from measuring the temperature of the bottle or materials in the bottle, instead of the person the paint is touching. The temperature sensor 380 includes a series of dots, arranged in an array with two axes. One axis is in one degree interval, and the other is in 0.2 degree interval. In the figure, the temperature is 99.2 degrees Fahrenheit. The temperature sensor 380 can be laminated into a label on the bottle 375. To use the thermometer 380, for example, the user can hold the bottle 375 against her forehead for a duration of time. Then the user pulls the bottle 375 away from the forehead to read the temperature. The bottle 375 shown includes two compartments. One compartment 377 can be for medication, and another compartment 379 can contain a type of beverages, such as water, for the user to drink.

In one embodiment, the substance in a bottle is stored in a bag. When the substance is getting low and needs to be replenished, the user can order another bag of the substance and replace the old bag with the new bag, while using the same bottle.

In one embodiment, one or more compartments are detachable. For example, the compartment holding electrical components is detachable. The user can detach the electronic compartment and wash the bottle, such as with a dishwasher.

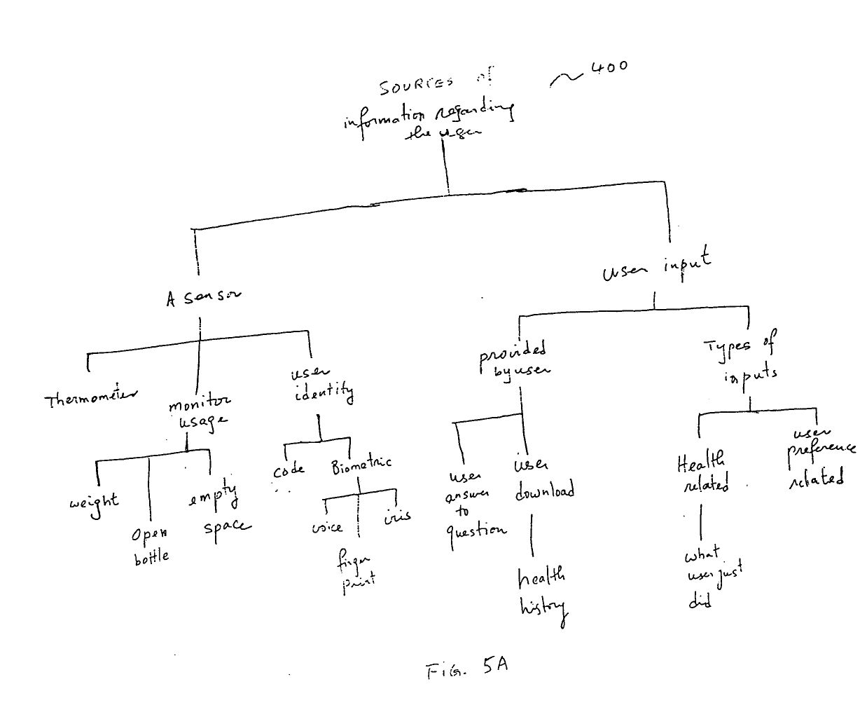

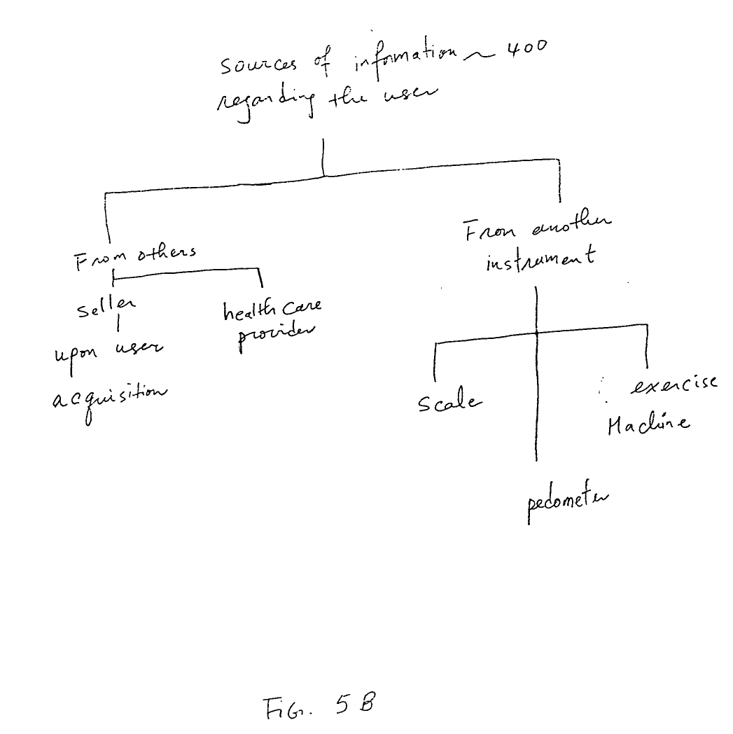

A bottle can hold information electronically regarding the user. The personal information of the user can come from different sources. FIGS. 5A-5B show examples of the sources of the personal information 400 according to different embodiments. In one embodiment, the bottle can be considered personal to the user if the bottle holds personal information of the user, such as electrically holds the information.

In one embodiment, the personal information is from a sensor. The sensor can be a sensor that measures a health condition of the user. As an example, the sensor is a thermometer. After temperatures are measured, the bottle keeps track of the measured temperature, which can include the time when each temperature was measured.

The amount of the substance that has been consumed by the user can be kept track of. For example, a scale can keep track of the weight of the bottle. As the user takes the substance, the weight of the bottle is reduced. The scale can be in a base that the bottle sits on. More discussion regarding the base will be found below. In this example, the bottle is assumed to be personal to the user, and only the user takes the substance in the bottle.

Another type of information regarding the user is the user's identity. In one embodiment, the bottle includes a biometric sensor that can be used to sense the identity of the user. The biometric sensor can be based on the user's voice, the user's fingerprint and/or the user's iris.

In one embodiment, a bottle includes a fingerprint sensor to serve as a key to access the information stored in the bottle. The fingerprint sensor can also serve as an on/off switch. As the user presses onto the sensor, the sensor is activated. If the sensor authenticates the fingerprint to be the fingerprint of the user, other electrical components in the bottle will be activated. Otherwise, the user cannot use at least one electrical component in the bottle.

In another embodiment, the bottle stores a code entered by the user, and the code can be used to identify the user. The code can be an alphanumeric string of characters. Upon entering the code, the user can use other electrical components in the bottle.

In one embodiment, the source of information regarding the user is from the user's input. For example, the user provides the inputs by responding to questions from a bottle. The bottle can present one or more questions to the user. Based on the user's responses to the questions, the bottle gathers information regarding the user. This can be done through a speaker and a microphone on a bottle, or through questions shown on a display of the bottle.

Instead of responding to questions from a bottle, in another embodiment, the user downloads information into a bottle. This can be done from, for example, a memory card or a computer. For example, the user can download information regarding his health history into a memory in the bottle.

There can be different types of inputs by the user. The inputs can be related to the condition of the user. For example, it can be the user's response regarding whether the user has eaten yet to find out if the user has an empty stomach before taking the content in the bottle. In one embodiment, the inputs can be related to the user's preference. For example, the inputs can be a piece of contact information, such as the cell phone number, of the user, or an email address of a healthcare provider. This allows the bottle to contact the person the user prefers, if the bottle has such capabilities. In another example, user preference includes the songs, or the tunes, which the user likes and/or dislikes. The songs can be downloaded into the bottle.

Information regarding the user 400 can be from another person or entity. In one embodiment, the information is from the seller or dispenser of the bottle with the substance inside. For example, when the user gets the bottle with medication from a pharmacy, a pharmacist can download information regarding the user into the bottle. There can be a barcode or other identifier that includes or points to information regarding the user, such as the user's name. The pharmacist can scan the barcode or use the other identifier. After capturing the information, the information can be downloaded to the bottle. As another example, the information is from a healthcare provider of the user. The user can go to see the provider, who can download information regarding the user into the bottle.

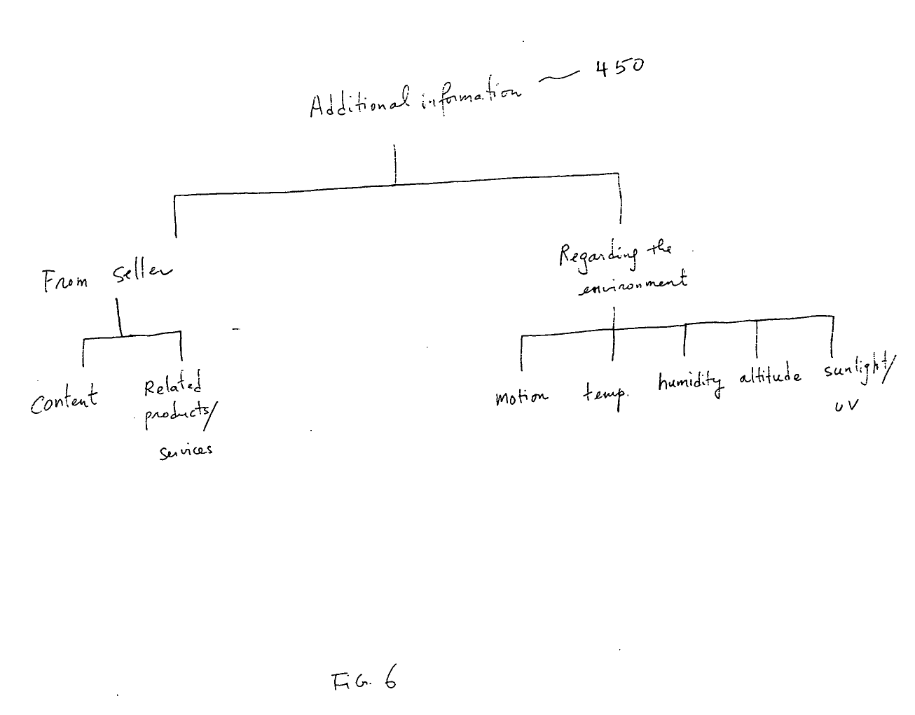

Instead of information regarding the user, the bottle can store other types of information. FIG. 6 shows examples of other types of information 450 in a bottle according to different embodiments. For example, the bottle can store information from a supplier of the bottle with the substance insider, such as a seller or a dispenser, regarding the content or the substance. The seller can be a drug company, and the dispenser can be a pharmacy or a drug store. These can be specific information regarding the substance, such as its side effects, precautions regarding the substance, its interactions with other drugs, health news related to the medication, and/or consumer awareness information. For example, the substance is a type of medication, and the stored information is about the medication. Compared to information printed on a label pasted on the bottle, more information can be stored electronically. Also, if the bottle has a display, information stored can be shown on the display. The dimension of the information shown on the display can be adjusted according to the preference of the user. For example, some people might prefer to read texts with larger font size. Others might be comfortable with smaller font size. In one embodiment, the font size on the display can be adjusted according to needs of the user. In another embodiment, there is a default font size (or the font size is fixed), which is large enough to be read by a typical person without the need of straining his eyes. Alternatively, information can be output in an audio manner, such as using text-to-speech conversion or audio files.

In yet another embodiment, the information stored in the bottle can be on products/services related to the substance provided, or other products/services provided, by the seller or the dispenser.

In one embodiment, a bottle also stores information related to the bottle's immediate environment. For example, the bottle keeps track of the information from a motion sensor in the bottle. The motion sensor keeps track of motions in the immediate vicinity of the bottle.

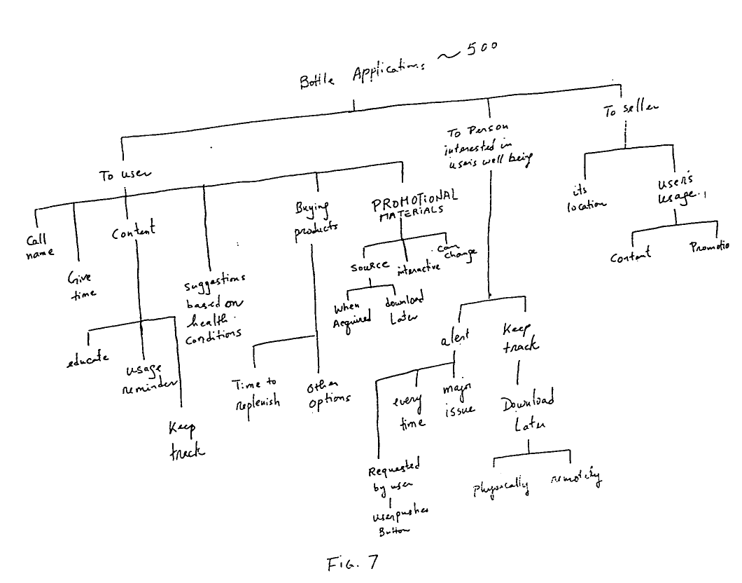

FIG. 7 shows examples of different applications 500 by a bottle according to different embodiments. In one embodiment, the bottle provides information and/or recommendations to a user. For example, the bottle can announce the name of the user when the user activates the bottle. The bottle can give the user the time. The bottle can educate the user regarding the substance in the bottle.

In one embodiment, the bottle keeps track of the usage of the substance in the bottle. Based on the usage, the bottle can determine user compliance, or whether the user has been following the recommendation of a health care provider on when and how much to take the substance in the bottle. In another embodiment, the bottle can determine user abuse in taking the substance in the bottle. For example, the bottle carries a controlled substance, and the user can take significantly more than the recommended amount, in turn causing substance abuse. In yet another embodiment, the bottle can determine user mistakes, such as incorrect dosage being taken by the user.

In one embodiment, the bottle can remind the user when to take the substance in the bottle, how much the user should take, when the user should take again and/or reprimand the user for not taking the substance for a duration of time.

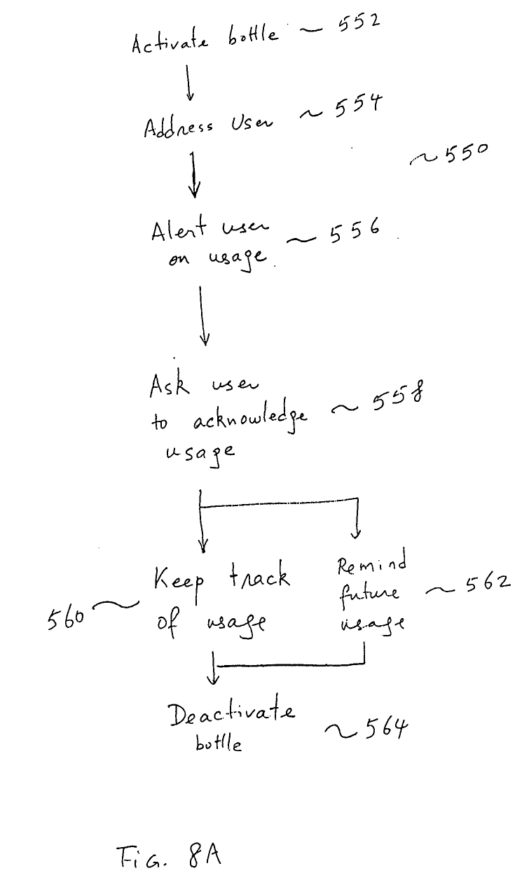

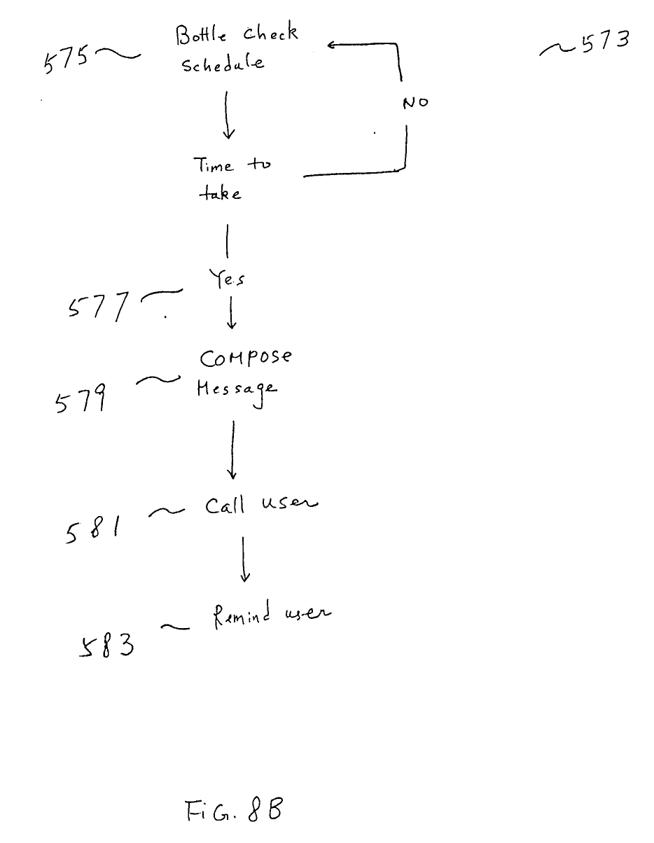

FIG. 8A shows a process 550 executed by a bottle regarding the use of the substance in a bottle according to an embodiment. The user activates 552 the bottle. This can be, for example, done by the user turning on the electronics in the bottle. Upon activation, the bottle addresses 554 the user. For example, the bottle says, “Hello, Angeline.” Then, based on usage information, the bottle alerts 556 the user on usage, such as the user should have taken the medication in the bottle two hours ago. For example, the bottle says, “Angeline, you should have taken two tablets of Aspirin two hours ago.” In addition, the bottle can ask the user if the user has eaten anything in the last hour because based on information regarding the medication, one should not take the medication with an empty stomach. For example, the bottle can ask the user, “Angeline, have you eaten anything in the last hour?” If the user answers “no”, the bottle can tell the user to eat something before taking the medication. There can be a “yes”/“no” button on the bottle to allow the user to respond to queries from the bottle.

The bottle can also remind the user to acknowledge 558 the use of the substance in the bottle. For example, the bottle can say, “Angeline, after you have taken the tablets, please push the blue button on the bottle.” After the user has taken the medication, the user can push the blue button on the bottle. This would facilitate the bottle to keep track 560 of information related to the user's usage. The bottle can also remind 562 the user when the user should be taking the substance. For example, the bottle can say, “Angeline, you should be taking two tablets of Aspirin in 4 hours, or around 5 pm today.” With no other activities after a predetermined duration of time, the bottle deactivates 564 itself, such as by having its electronics go into a sleep mode or turning itself off.

Instead of waiting for the user to activate, the bottle can proactively send a message to the user, or to another person or entity. FIG. 8B shows a proactive process 573 executed by a bottle according to one embodiment. In this example, the proactive process is related to sending a message. For example, the bottle checks 575 a medication schedule of the user to determine if it is time for the user to take medication. If it is not the time yet, the bottle waits. If it is time 577, the bottle will compose a message 579 for the user. For example, the bottle can include a number of templates. One template can be as follows: “[Name], this is your friendly [medication] bottle calling. Time to take your medication.” Instead of just saying the medication, the prescribed amount can also be included in the message, such as two pills. The bottle can retrieve the appropriate template, and enter the user name, the medication name, and other relevant information into the template. The bottle can also retrieve a phone number. The phone number can, for example, be a cell phone number, or a desk/wall wired phone number. This phone number may be entered, for example, by the user or the user's healthcare provider. The bottle then composes 579 the message, which can be, “Tom, this is your friendly Aspirin bottle calling. Time to take two pills!” After the composition, the bottle calls 581 the user, and reminds 583 the user by sending the user the composed message.

In one embodiment, the user can be reminded by different types of songs or ring tones. If the user takes the medication at the right time, the bottle can reward the user with a happy song, or a song that the user likes. If the user takes the medication at the wrong time or takes the wrong amount, the bottle can reprimand the user with a sad song upon identifying the mistake. In another embodiment, the bottle can remind the user when it is time to take the medication with a pleasant song. If the user ignores the reminder and does not take the medication for a preset duration of time, the bottle can play an annoying song. The different types of songs, or sound clips, which can be a few seconds of a song, can serve the functions of rewards/punishment and/or motivation for the user to take the medication at the appropriate time.

In one embodiment, the bottle can allow the user to record messages, which can be voice messages. These messages can be time-stamped. These messages can also be linked to measurements made by the sensor, such as the thermometer. For example, after the user has measured his temperature, the user can record a message as to how he feels. Such information can be recorded for later retrieval.

The bottle can help the user regarding buying products. For example, the bottle can keep track of the amount of the substance in the bottle. When the content is getting low, the bottle can remind the user that it is about time to replenish. The bottle can provide suggestions to the user as to alternative substances to acquire. This suggestion can be based on the user's characteristics. For example, the user typically has high fevers. Based on such information, the bottle can suggest the user to buy Motrin, instead of Aspirin. In one embodiment, the bottle can upload such information to another device, such as a computer, which can add Motrin to other medications the user needs, to assemble a list. Next time when the user is about to go to a drugstore, the user can access the updated list from the computer as a reminder. Alternatively, the user can send the list to a computer at the drugstore, which allows the user to access the list when the user gets there. For example, there could be a kiosk with a computer at the drugstore, and the user can access the list via the computer.

In one embodiment, the bottle can provide promotional materials to the user. The materials can be an advertisement shown on a display on a bottle to promote products and/or services offered by a company. Such products and/or services can be related to the substance in the bottle. The promotional materials can be from a supplier of the bottle with its substance. They can come with the bottle when the user buys the bottle. Or, they can be downloaded to the bottle after acquisition. For example, the user can connect the bottle to the company's website to download such information into the bottle. In one embodiment, when the user visits the website of the company, the user may be encouraged to connect the bottle to the website, such as through a connector on the bottle. The company can give incentives to the user if the user is willing to allow the company to download company information onto the bottle. The incentives, for example, can be discounts or coupons for the company's products, which can include services.

In one embodiment, the product promoted can change. This change can be based on time. For example, every week the display can change the product shown, such as the display showing a type of health tea on one week and automatically changing to a type of vitamin the next week. The type of product promoted, such as the vitamin, can be more suitable for the user as indicated by the measurements from a sensor coupled to the bottle, such as the thermometer.

In one embodiment, the promotional materials can be interactive. There can be embedded hyperlinks and/or pop-up windows in the promotional materials, which allow the user to interact with the promotional materials.

In one embodiment, a bottle can provide information and/or recommendation to a person or entity interested in the well being of the user, such as a relative, a healthcare provider, a doctor, a nurse, a social worker, or the police.

The bottle can keep track of the user, such as the user's temperature to assist, for example, a healthcare provider. Such information can be stored in the bottle for future download. The download can be done remotely or locally. For example, the user can download the information to the healthcare provider's website through the user's computer. Or, the user can take the bottle to see the healthcare provider, allowing the healthcare provider to access the stored information. In another embodiment, such information can be wirelessly sent, such as through a cellular connection, to the person interested in the well-being of the user. In yet another embodiment, the person can also access the information wirelessly such as, by cellular connection. This can be done, for example, by allocating a cellular phone number to a cellular phone embedded in a bottle, which can allow the person to directly access the information.

In one embodiment, the bottle can send stored information to a person or entity interested when there is a critical issue. For example, if the temperature measured is beyond 104 degrees, the bottle can automatically send a message to the family doctor of the user. In another embodiment, the bottle can send an instant message to a relative of the user every time the user takes the substance in the bottle, or every time the user takes a measurement.

In yet another embodiment, the bottle can send information to a person or entity as requested by the user. For example, there might be a special button on the bottle. The button activates a special-purpose phone, such as when pushed, a special number will be dialed. In one embodiment, the most recent data, such as data captured within the last twenty four hours will be sent to the recipient.

In one embodiment, the bottle provides information and/or recommendation to a supplier of the bottle with the substance inside the bottle. For example, the bottle keeps track of its own location from the manufacturer to its dispenser or retailer and to the customer, such as from the big pharmaceutical company where the medication is produced, through the distributors, to pharmacies or hospitals. In one embodiment, such tracking can help ensure the drug produced is the same as the one being given out to the consumers; or such tracking reduces the chance of the drug produced being tampered with before reaching the consumers. Such tracking can also help reduce the problem of losing medical supplies or reducing the chance of having insufficient supplies of certain medication at hand. Such location information can be automatically forwarded to the entity interested, such as a hospital, distributor, manufacturer or pharmacy.

In another embodiment, the supplier can be aware of the user's usage. For example, a seller is aware of the substance getting low, or the seller can keep track of the usage of the substance each time the user uses it. In another embodiment, the seller is aware of the user accessing promotional materials, such as tracking the use of the hyperlinks and/or pop-up windows. This allows advertisers to gather information about what the user shows interest in (e.g. clicks on), and determine effects on sale of products. Such information can be transmitted to the seller through the bottle's electrical connection, for example, through the bottle's wireless connections.

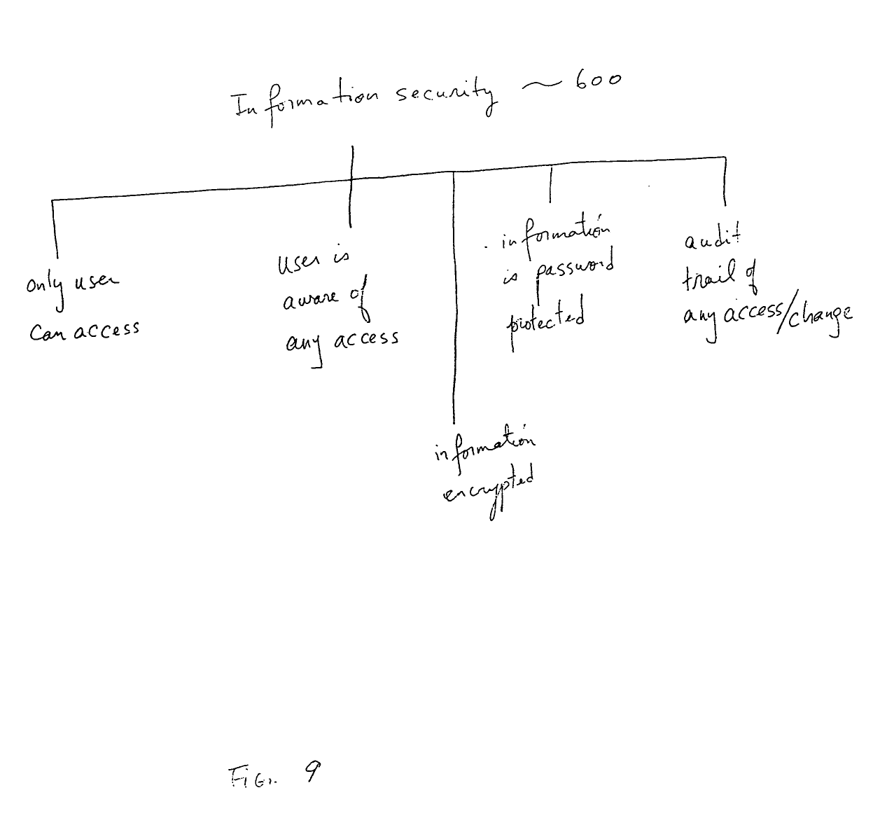

Information stored in the bottle can be sensitive, particularly to the user. FIG. 9 shows examples of different attributes on information security 600 regarding a bottle according to different embodiments. In one embodiment, the information is secured. For example, only the user can access the information. This can be based on a biometric sensor. The information can be password protected. A code (e.g. password) can be entered to activate the bottle or to allow a person to access information in the bottle. In one embodiment, the information is encrypted. One needs the right key to decrypt the information in order to use it.

In another embodiment, the user is aware of any access. This can be whenever the information is accessed. For example, the bottle can send the user an electronic message whenever any of the information is being accessed. In another embodiment, the bottle keeps track of data access and changes made to the data. Such information can serve as an audit trail.

A number of embodiments have been described regarding a bottle. In one embodiment, a bottle is defined as a container or a receptacle that has a narrow neck. In another embodiment, a bottle is defined as a container or a receptacle with a width that is not uniform (some part narrower than another part, such a neck portion being narrower). In yet another embodiment, a bottle does not have to have a narrow neck and a bottle can have uniform width or substantially uniform width, but the bottle has an opening or a mouth that can be plugged, corked or capped. For example, the cap can be removed to expose the opening or the mouth. In still another embodiment, a bottle is portable if it can be carried or moved with ease by a person. In yet another embodiment, a bottle is portable if it can be handheld, or if it can be carried by hand.

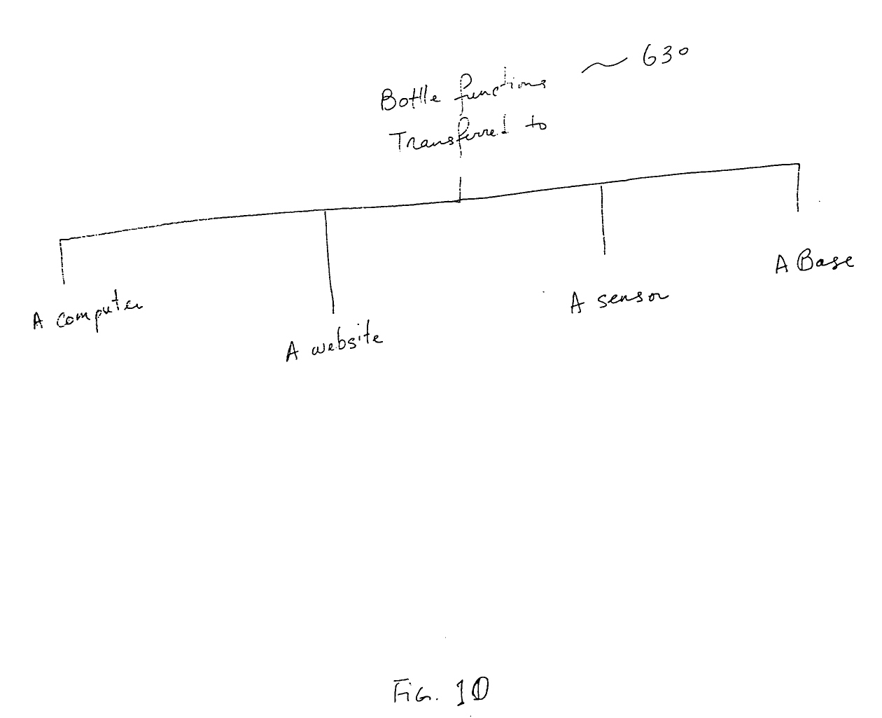

FIG. 10 shows examples of at least some of the functions previously described as performed by a bottle, being performed by 630 another device. In one embodiment, a number of the functions are performed by a computer coupled to a bottle, through, for example, a connector at the bottle. In another embodiment, instead of a computer, a number of functions are performed by a remote website, wired or wirelessly coupled to the bottle. In yet another embodiment, instead of the bottle, a number of functions are performed by a sensor, such as a thermometer, coupled to the bottle.

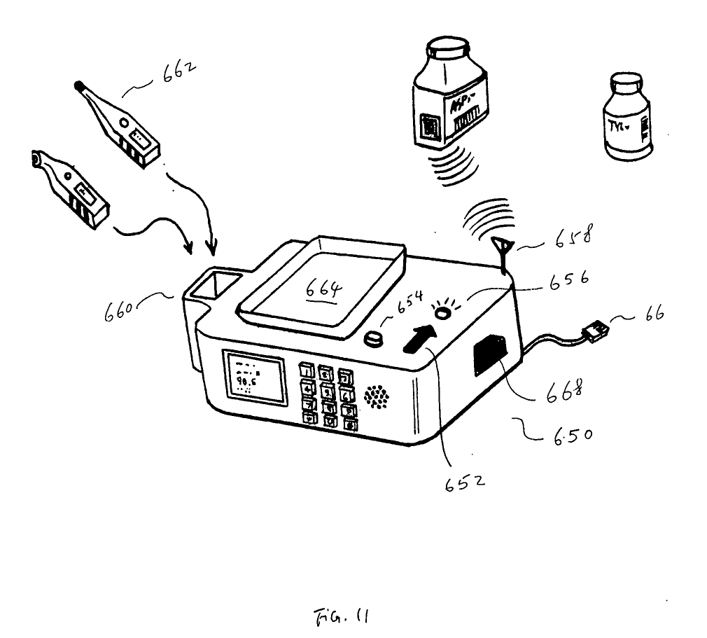

In one embodiment, any of a number of functions previously described as being performed by a bottle can be performed by a base. FIG. 11 shows one embodiment of such a base 650, which can be electrically coupled to a bottle.

In one embodiment, in such a base implementation, operations performed by a bottle can be minimized. For example, when the user gets his medication from a pharmacist, the bottle can include information regarding the prescription, which can include the user's schedule to take the medication. Such information can be on a barcode, a RFID tag or in a memory in the bottle, according to different embodiments. The user can download such information into the base. For example, if the information is in a barcode on a bottle, the base can include a barcode reader 652. The user can push a start button 654, and then the user can scan the barcode to enter such information into the base 650. When the barcode is successfully scanned, a signal can be provided to the user, such as a light 656 can turn on, or a signal can be provided by a speaker.

Note that different pharmacies might use different barcodes. In one embodiment, information regarding different barcodes from the different pharmacies is stored in the base.

In one embodiment, the base can include a RFID tag reader, including its antenna 658, to access the information stored in an RFID tag on the bottle.

Alternatively, the bottle can include an electrical connector. The user can connect the bottle's connector to a base connector to download the information. In one embodiment, the bottle's connector is at the bottom of the bottle. There can be a recessed space on top of the base to receive the bottle. When the user puts the bottle into the space, with the bottle's connector received by the base's connector, information in the bottle can be downloaded into the base. In one embodiment, the bottle's connector can be at the bottom of the bottle. The bottle's connector can be a standard connector, such as a USB connector. The connector can be slightly recessed into the bottle, allowing the bottle to firmly stand on a flat surface, without the connector sticking out. In another embodiment, the connector can be a connector with two conducting pads or conductors, such as one conductor for signal and the other being ground.

In one embodiment, the base includes a slot 660 to receive a sensor 662, such as a thermometer. The slot 660 can be used to track different measurements regarding the user. Each time a sensor is stationed in the space, such as inserted into the slot 660, measurements made by the sensor 662, such as in the past 24 hours, are uploaded to the base 650. The upload can be through a connector at the sensor 662 with a corresponding connector at the base 650.

In one embodiment, the base 650 can also include a scale 664. The user can weigh a bottle with the scale 664. The scale 664 can also be at a recessed space on top of the base 650 to receive the bottle. In another embodiment, as the bottle sits on the scale 664, its RFID tag is read by a RFID tag reader in the base 650.

In another embodiment, the base can have multiple recessed spaces for more than one bottle. The base can also have multiple slots for more than one sensor to be stationed.

In another embodiment, the base 650 can include a connector 666 to connect to other devices or instruments, such as a computer. Instead of a physical connector, the connection can also be wireless. Based on such connections, the base 650 can be connected, for example, to another area, such as a website. Information in the base 650 can be accessed and the base 650 can also access information from the another area, such as the website. In yet another embodiment, the base can also include another input/output connector 668, which can be for a memory device, such as a flash memory card.

In one embodiment, the base can keep track of the time, the date, the weight of a bottle, the medication, sensor measurements and/or the user identity. For example, every time the user uses a bottle of medication, the user can place the bottle on a selected space on the base to weigh the bottle and to upload information into the base. This would allow the base to keep track of information related to the user taking the medication.

In one embodiment, since the bottle can keep track of the type of substance taken by the user, as the user takes different types of substances, such as from different bottles, the information regarding the substance can be downloaded into the base accordingly. Based on information in the base, or information accessed from a remote site or area, the base can provide indication to the user that the different types of medication the user is taking, conflict with each other and can cause complications to the user.

In one embodiment, a base is, or performs the functions of, a medical monitoring system. In another embodiment, a base can be considered personal to the user in the sense that the user typically does not want to share it with another user if the another person is using the base for similar purposes as the user. This can be similar to a toothbrush, which is usually considered personal to the user. However, the user may be willing to let a healthcare provider use it because the provider is typically using the base for different purposes, such as to access information from it to diagnose the user.

In another embodiment, a base could be used by a number of users. The base can keep track of information regarding each user, and the one or more bottles used by each user. The base could also restrict one user from accessing information belonging to another user.

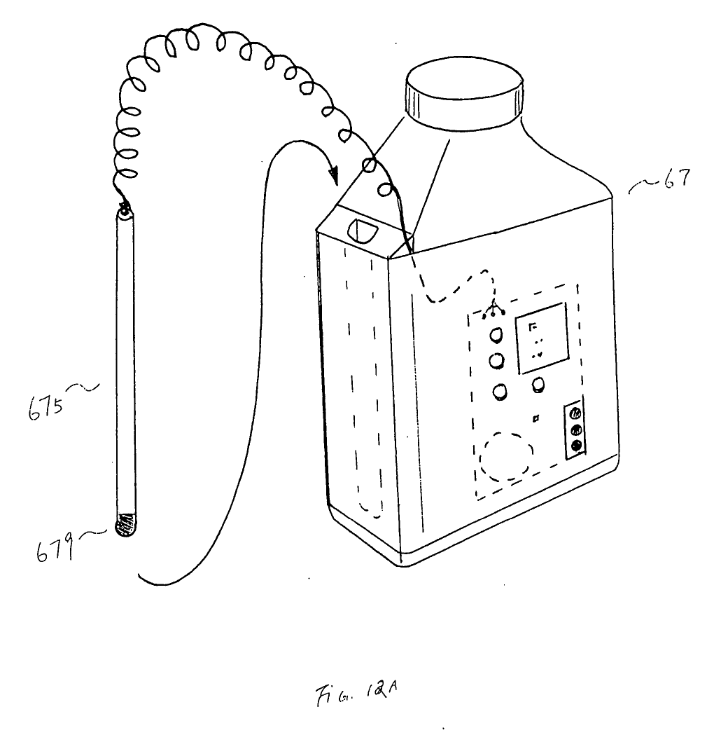

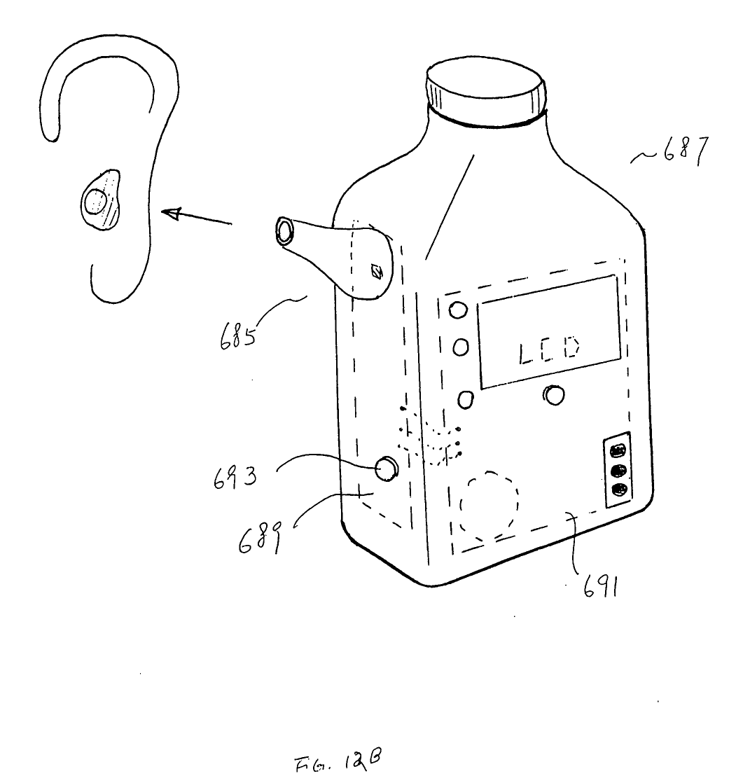

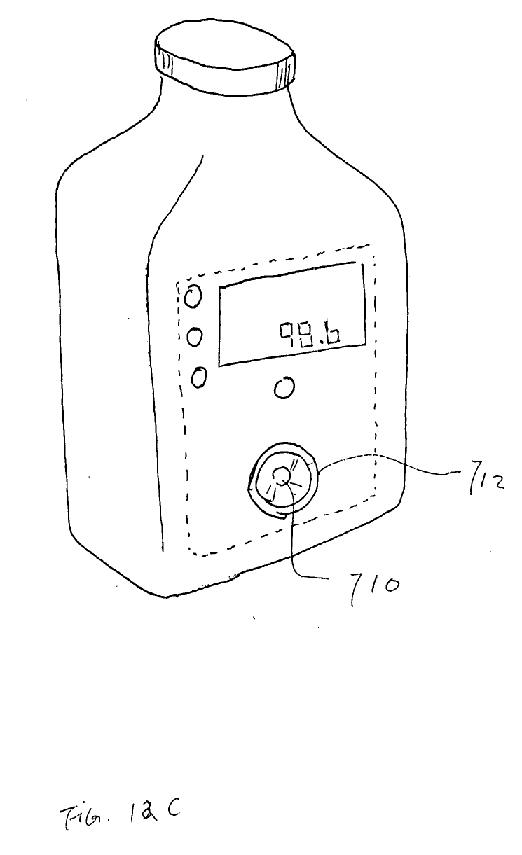

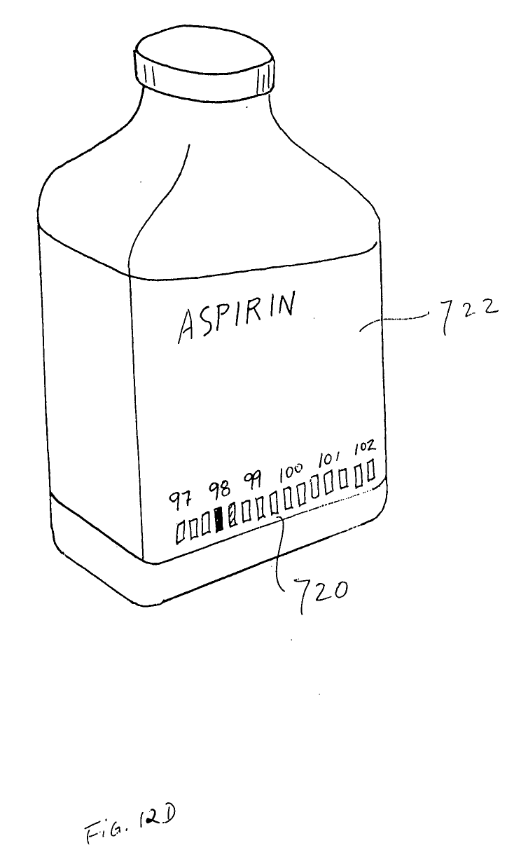

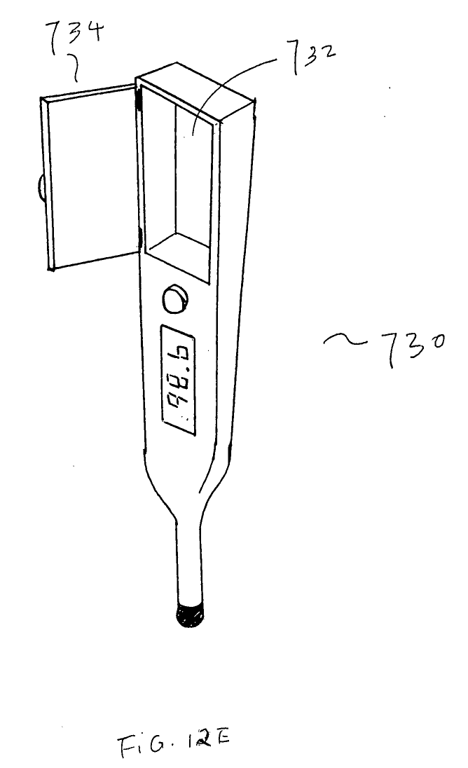

FIG. 1 shows one type of thermometer to measure the user's temperature. FIGS. 12A-E show examples of other types of thermometers according to different embodiments.

In FIG. 12A, the temperature sensor 675 is tethered to a bottle 677. In this example, the temperature sensor 675 does not include any display. The temperature sensor 675 has a heat sensor 679 at its tip. The bottle 677 keeps track of temperatures measured.

FIG. 12B shows an infrared ear thermometer 685 on a side surface of a bottle 687. In this example, the bottle 687 can include two printed circuit boards, 689 and 691, as shown. The on/off button 693 for the infrared ear thermometer 685 can be on the side surface circuit board 689. In another embodiment, the on/off button is located on the front surface circuit board 691.

FIG. 12C shows an infrared sensor 710 in a ring structure 712 for measuring the temperature of a surface. For example, the surface can be the forehead of the user. Such sensors are known to those skilled in the art and are discussed, for example, in U.S. Pat. No. 6,292,685, which is hereby incorporated by reference in this application.

In FIG. 12D, the thermometer 720 is made of thermochromic paint attached to a surface of a bottle 722.

FIG. 12E shows a sensor 730 with a box 732 that has a lid 734. The box 732 can be used to carry pills or other medication, such as a pill box. The sensor 730 can also include an electrical connection, such as a physical connector or a wireless connection, to electrically couple the sensor 730 to another device.

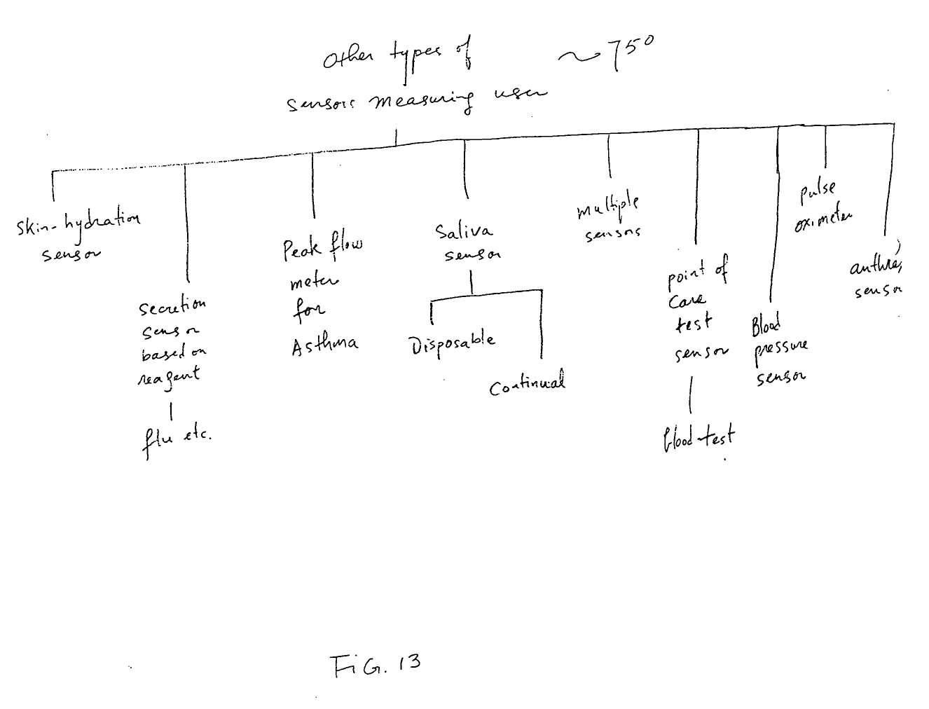

Instead of a thermometer, FIG. 13 shows examples of other types of sensors 750 to provide different types of health information regarding the user according to different embodiments. One or more of such sensors can be used with or without a bottle for the user. Different examples of such implementations have been described in U.S. Provisional Patent Application Ser. No. 60/670,957, entitled, “Bottle of lotion with a lotion sensor,” which is hereby incorporated by reference.

In one embodiment, the sensor is a skin hydration sensor or a lotion sensor and the bottle is for holding lotion.

In one embodiment, the sensor is a blood pressure monitor. In another embodiment, the sensor is a pulse oximeter.

In yet another embodiment, the sensor is an anthrax sensor, such as using PCR based test, which can be applicable to a bio-terrorism environment. The corresponding bottle can carry the antibiotics against anthrax.

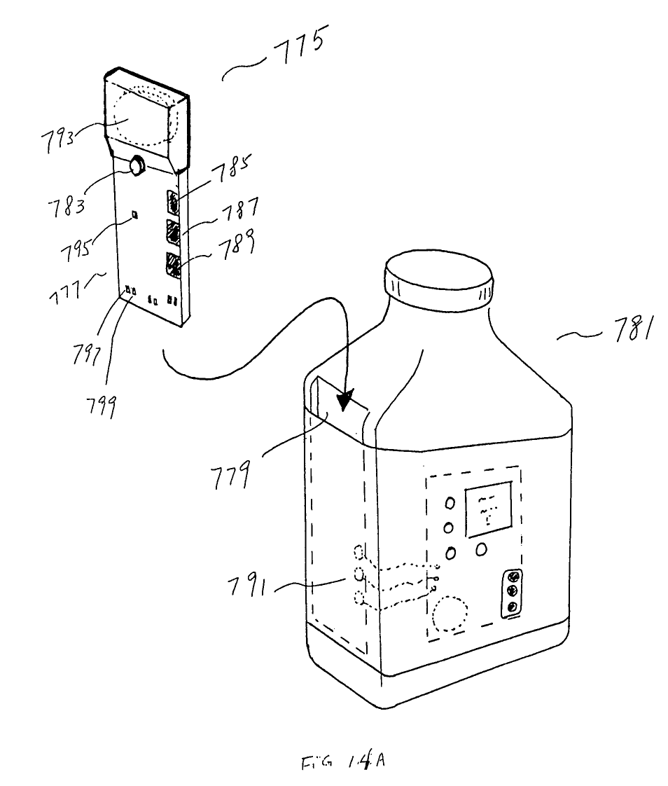

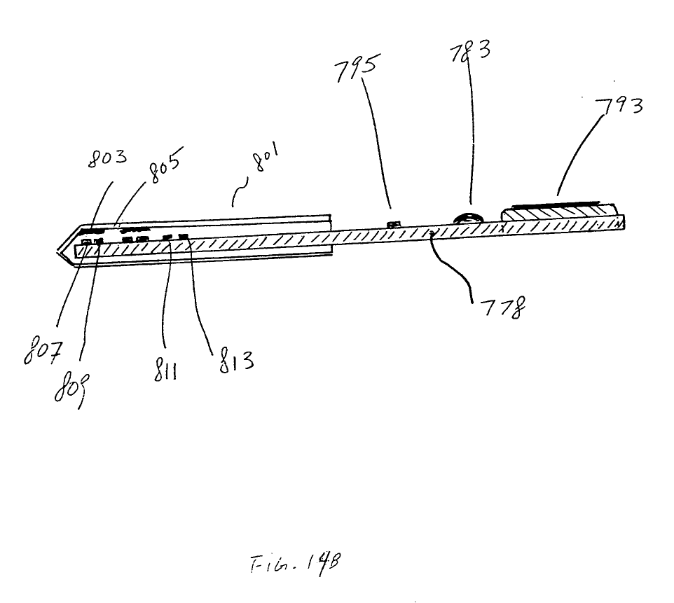

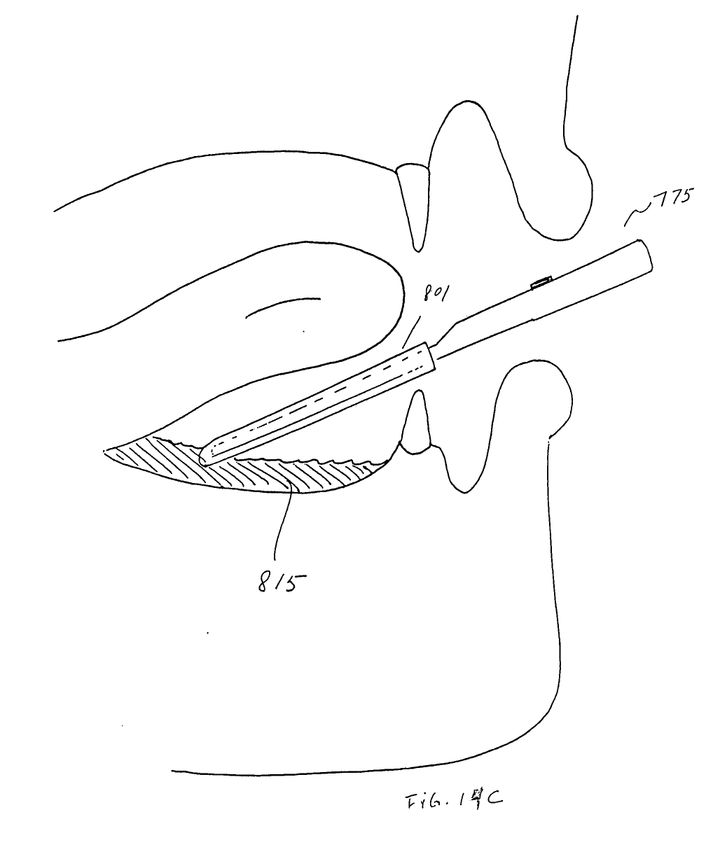

In one embodiment, the sensor is a secretion/excretion sensor based on a reagent, and the bottle holds medication, such as, for example, for flu/cold/strep-throat. The secretion/excretion can be, for example, saliva, sweat, urine, or stool, depending on the embodiment. FIGS. 14A-C show different embodiments of a reagent sensor according to different embodiments, with the sensor 775 including a sensor head 777 and a disposable sensor tube 801 carrying reagents.

As shown in FIGS. 14A-B, the sensor 775 includes a sensor head 777 adaptable to be inserted into a slot 779 of a bottle 781. The electrical components of the sensor head 777 can be on a printed circuit board 778. The board includes an on/off switch 783 to activate the sensor head. The board also includes a number of connecting pads 785, 787 and 789, to electrically connect to a number of corresponding pads 791 at the bottle 781. The board can also hold a battery 793 as a power source, and a microcontroller unit 795 to control operations.

In one embodiment, the sensor head 777 includes a number of light emitting diode and photodiode pairs, such as 797 and 799. For example, there can be two such pairs, each pair for one type of reagents. To be explained below, an extra light emitting diode and photodiode pair can be used to identify the reagents. In another embodiment, the extra pair can serve as a base line of the electrical measurements.

In one embodiment, the sensor tube 801 includes reagents 803 positioned or printed on a piece of absorptive material, such as a filter paper 805 that is in the form of a tube or envelope. The reagents are on the inside of the tube 801. There can be a piece of plastic or other transparent materials covering the reagents on the inside of the tube. The transparent materials can serve as the inner lining of the tube and can serve to provide structural strength for the tube. The tube creates a channel to receive at least a portion of the sensor head 777.

An alignment mechanism can indicate that the tube 801 and the sensor head 777 are at the appropriate locations relative to each other. In one embodiment, the alignment mechanism is based on pushing the sensor head 777 all the way into the end of the channel of the tube 801. At that position, each LED and photodiode pair is approximately aligned to their corresponding reagent, such as the pair 807 and 809, with their reagent 803. When the LED emits light, the photodiode receives the light of the LED reflected from the corresponding reagent.

There can be markings on the filter paper. The marking, such as bar codes, can be used to indicate the identity of the one or more reagents on the filter paper. The extra LED 811 and photodiode 813 can be used to read the markings. For example, the markings can be printed barcodes that are read as the tube 801 is slid on or off the sensor head 777. In one embodiment, as the sensor head 777 is inserted into the channel of the tube, the photodiode 813 keeps taking measurements.

FIG. 14C shows one embodiment of the reagent sensor 775 in operation. The sensor head 777 is inserted into a sensor tube 801. The sensor 775 is then placed inside the mouth of the user. The saliva 815 goes through the filter paper and reacts with the reagents positioned on the filter paper. Depending on the chemicals in the saliva, specific reagents will change color. Such color changes can be captured by the one or more photodiodes, with the information stored in the reagent sensor 775. After the measurements, the sensor tube 801 can be disposed. In one embodiment, since a piece of plastic separates the reagents from the sensor head 777, the saliva does not wet the sensor head 777, and the sensor head 777 may not need to be washed after every use.

With the sensor tube 801 disposed, the sensor head 777 can be inserted back into the slot 779 at the bottle 781. Measurements made by the sensor head 777 can then be uploaded into the bottle 781.

In one embodiment, the secretion/excretion sensor based on reagents can be used to measure the blood or other fluids of the user, based on different types of reagent.

In yet another embodiment, the sensor is a saliva sensor that can be used to determine whether a user is well hydrated. The corresponding bottle can hold a type of beverage. A number of embodiments regarding saliva sensing have previously been described in U.S. Provisional Patent Application Ser. No. 60/670,957, entitled, “Bottle of lotion with a lotion sensor”. The sensor can be disposable and the bottle can contain different types of beverages or fluids, which could include nutrients, vitamins, minerals, and/or medications. For example, the beverage can be vitamin C enriched water.

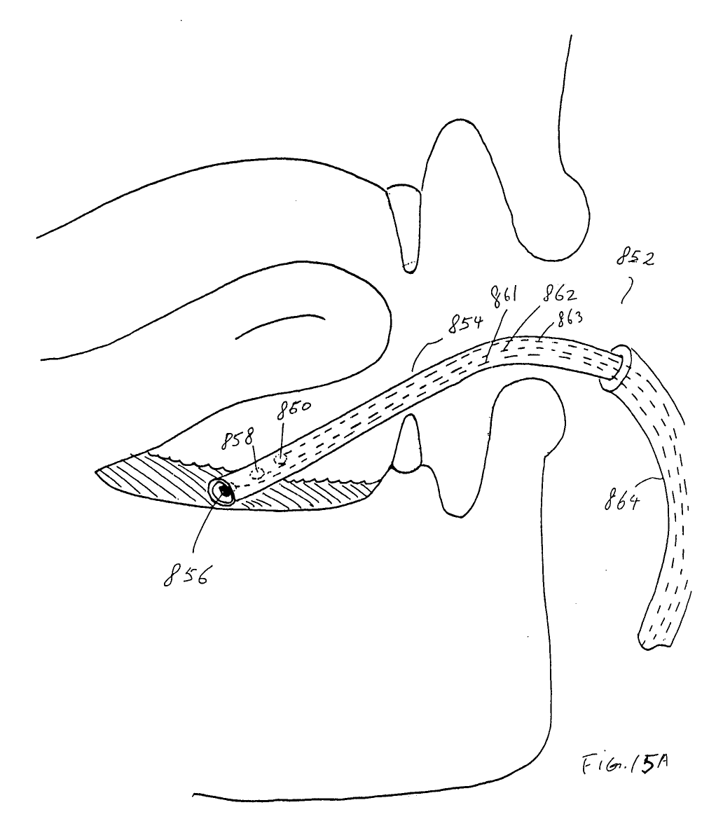

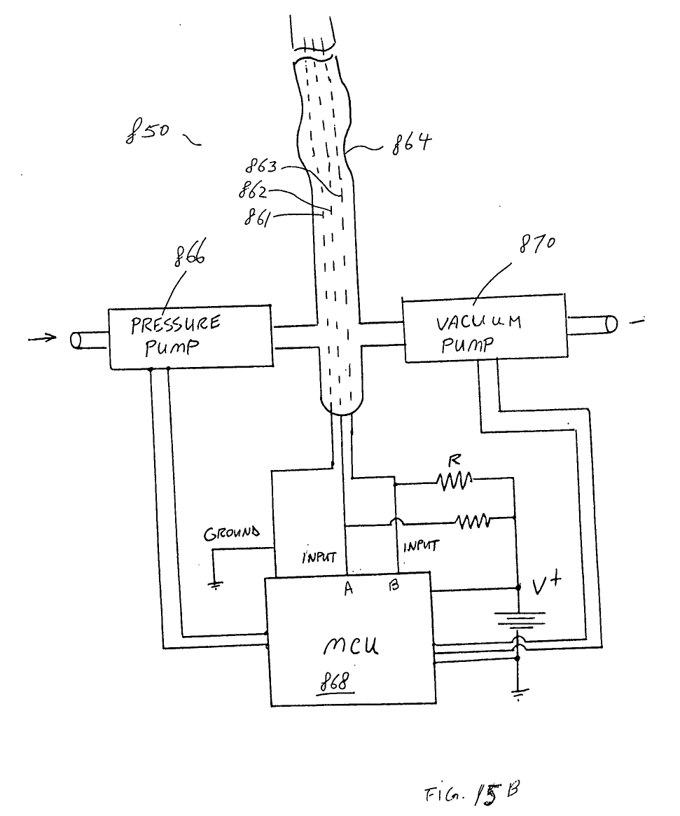

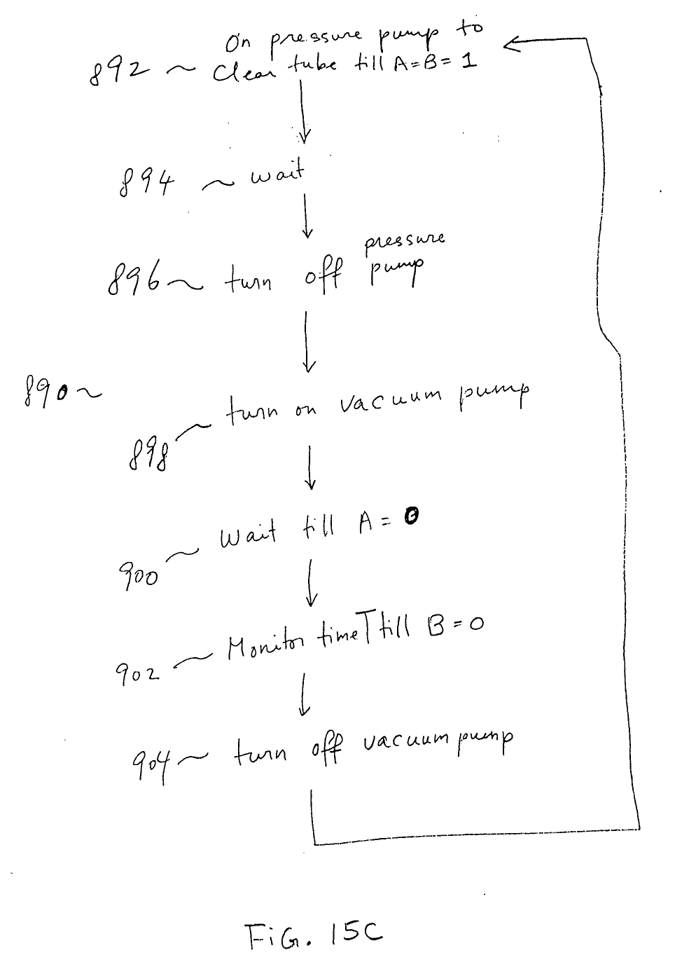

FIGS. 15A-C show a saliva sensor 850 that can continually measure certain attribute(s) in saliva according to different embodiments. FIG. 15A shows a sensor head 852 of the saliva sensor 850 inside the mouth, below the tongue in the saliva of the user. The sensor head 852 includes a hollow tube 854 with a small diameter. Because the tube's inner diameter is small, fluid can go up the tube based on capillary action. In one example, the tube has an inner diameter of 1 millimeter. The sensor head 852 includes three metal contacts, 856, 858 and 860, that are spaced linearly apart up the tube 854. The first contact 856 is close to or at the opening of the tube 854. The second contact 858 is at a certain fixed distance from the first contact 856, and the third contact 860 is further up the tube 854. Each contact is connected to a conducting wire or a conductor up the tube as shown in FIG. 15A, such as the wire 861 connecting to the contact 856, wire 862 to contact 858, and wire 863 to contact 860. In one embodiment, for structural reason, the wall thickness of the tube increases further away from the opening of the tube. In FIG. 15A, the hollow tube 854 is connected through an air-tight joint to another hollow tube 864 that has a thicker wall.

FIG. 15B shows a number of electrical components according to one embodiment connected to the conducting wires extended from the three metal contacts. FIG. 15C shows a set of operations 890 according to one embodiment based on the electrical embodiments shown in FIGS. 15A-B. First, a pressure pump 866 is turned on 892 to push air through the tube to clear saliva from the tube 862. With the saliva cleared from the tube 862, the inputs A and B received by a microcontroller unit (MCU) 868 will read high or logic 1. At this instant, saliva is not in the tube so the resistances between both the first contact 856 and the second contact 858, and the second 858 and the third 860 contacts are high. By keeping the pressure pump on for a preset amount of time, the tube remains clear during that period. This amount of time depends on how regularly the MCU 868 takes measurements. After waiting 894 for this amount of time, the MCU 868 turns off 896 the pressure pump 866 and turns on 898 a vacuum pump 870. The MCU 868 then waits 900 till the reading in its input A becomes ground or logic 0. At this instant, the resistance between the first 856 and the second 858 contact, through the conducting wires 861 and 862, is low due to the saliva touching the contacts. Then the MCU 868 monitors 902 the amount of time “T” until its input B also becomes ground or logic 0. At this instant, the resistance between the second 858 and the third 860 contacts, through the wires 863 and 862, is low, again due to the saliva. Then the MCU 868 turns off 904 the vacuum pump 870. This time T is proportional to the viscosity of the saliva, which depends on how well hydrated the user is. And the process can repeat.

Instead of using a pressure pump and a vacuum pump, in another embodiment, the user can blow into the tube 854 to clear the tube 854. The MCU can just keep measuring for the time T without the pumps.

In one embodiment, measurements can be based on multiple sensors sensing the user. For example, a saliva sensor and an activity sensor, such as a pedometer, can be coupled to a bottle. Based on both the saliva and the level of activity (or the lack of activity), the bottle can recommend appropriate fluid consumption for the user.

In another embodiment, the saliva sensor is separate from a beverage bottle. The sensor could be sold bundled together in a package with a number of bottles. Different packages could have different numbers of bottles. The sensor could be reusable, while the bottles could be disposable.

In one embodiment, the sensor can include a sensor in a point-of-care test. For example, the sensor is a blood tester, which can be a self-testing blood tester, such as for cholesterol test or hormone test. Another example of a sensor in a point-of-care test is a flu test sensor.

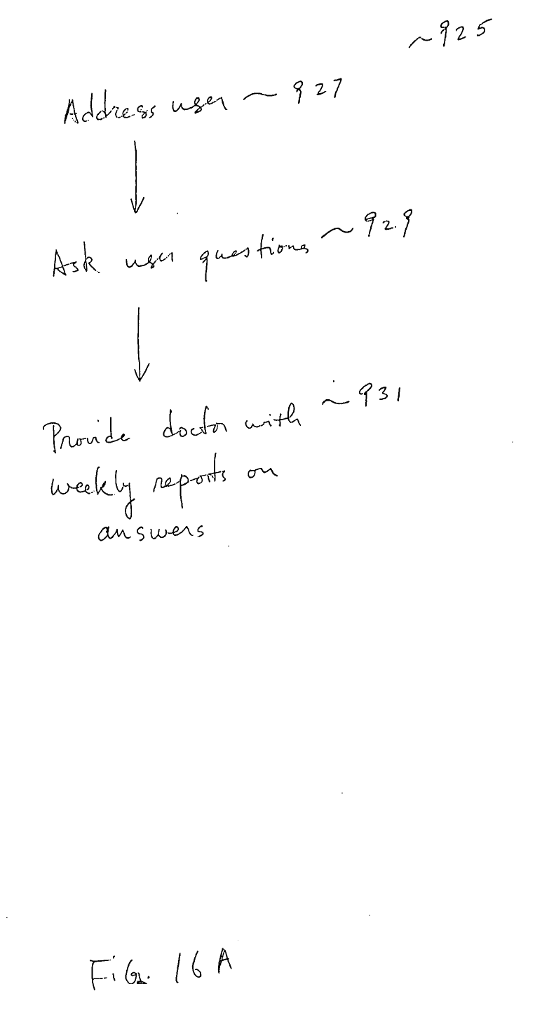

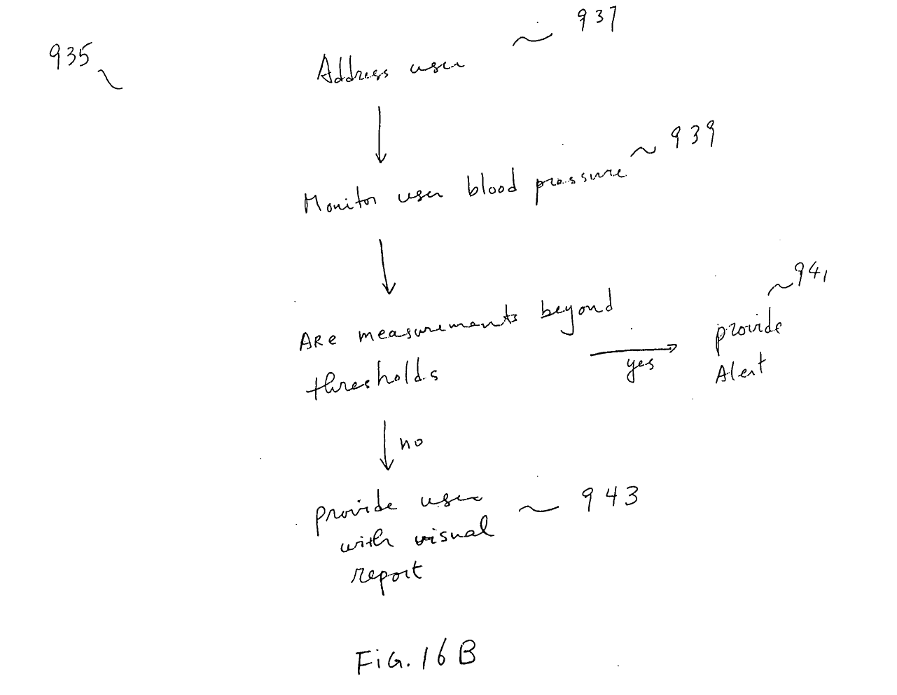

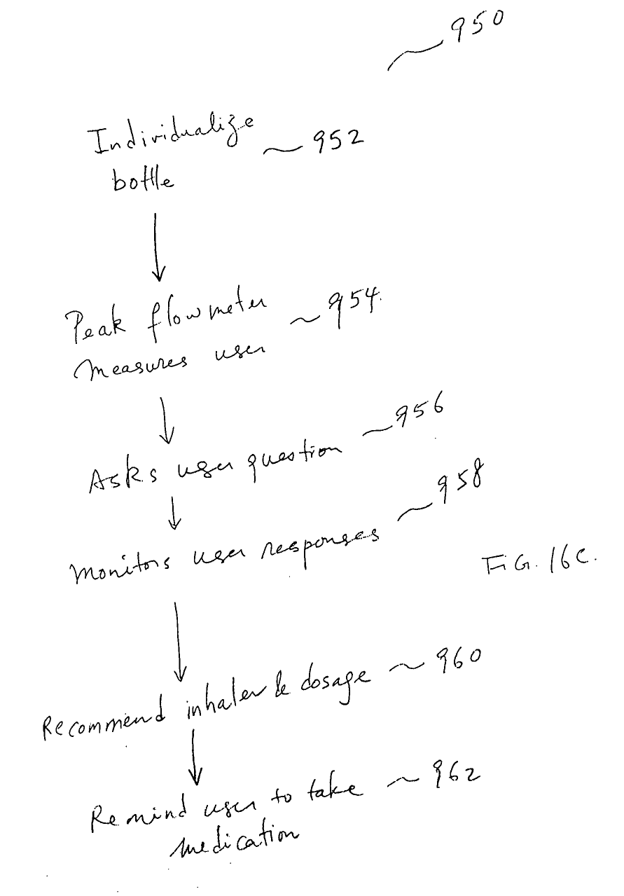

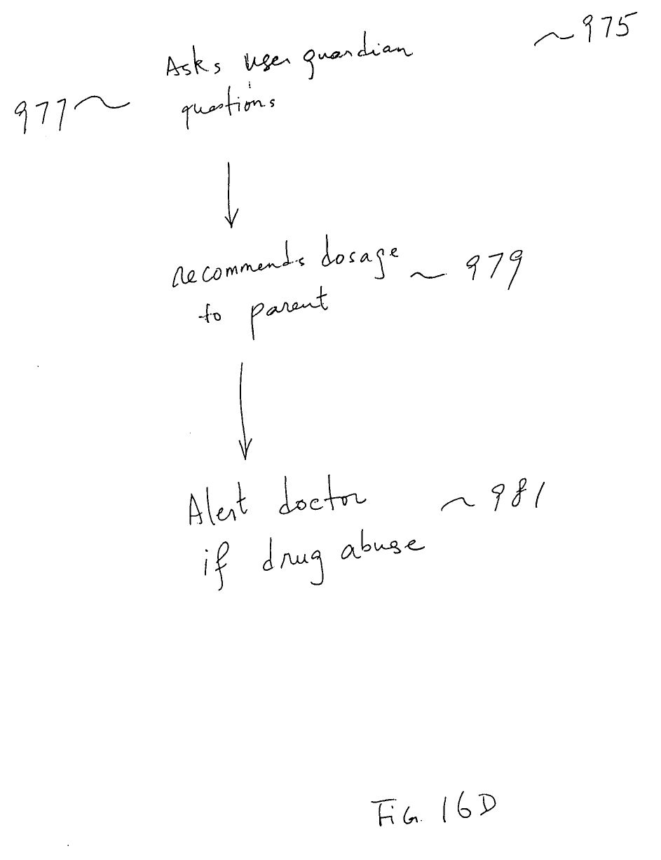

The substance in the bottle does not have to be limited to over-the-counter medication. In one embodiment, a bottle carries an antidepressant medication, such as Paroxetine or Fluoxetine. FIG. 16A shows a process 925 a bottle goes through according to one embodiment. After the bottle is activated, such as turned on each day, the bottle addresses 927 the user. Then the bottle asks 929 the user a number of questions. This can be based on a pull-down menu on a screen on the bottle. First, the bottle asks a question regarding the user's mood, and allows the user to select one out of a list of choices, such as very sad, sad, fed up, contented and happy. Then the bottle asks a question regarding the user's sleeping patterns, and allows the user to select one out of a list of choices, such as normal, not enough, and too much. The bottle can also ask the user a question regarding the user's activity level, and allows the user to select one out of a list of choices, such as cannot go to work, can go to work, function normally and function at 50% or less level. The bottle keeps track of the user's answers. Periodically, such as once a week, the bottle sends 931 the answers to the user's healthcare provider. The bottle can summarize the answers before sending to the provider. This can be done through a wired connection or wirelessly. Or, this can be done physically by the user visiting the health care provider with the bottle or with a memory device with information from the bottle. Based on the answers, the health care provider can adjust the future medication dosage accordingly, such as one pill a day, instead of two pills a day. The provider can also download the adjusted dosage to the bottle. Alternatively, instead of using a screen on the bottle to ask the user questions, the bottle can ask questions using audio (e.g., speech synthesis or pre-recorded audio).

In another embodiment, a bottle carries antihypertensive drugs. If the user has high blood pressure, both under and over dose can be dangerous to the user. The user can be a patient. In one embodiment, the user takes three different types of medication. They may include Diuretic, such as Hydrochlorthiazide, Ace Inhibitor, such as Captopril, and CA-Channel Inhibitor, such as Nifedipine. FIG. 16B shows a process 935 a bottle goes through according to one embodiment. When the user turns on the bottle, such as every day, the bottle addresses 937 the user, and suggests the user to measure his blood pressure. A blood pressure sensor can be coupled to the bottle, allowing the bottle to monitor 939 the measurements. If the measurements are beyond certain thresholds, such as systolic blood pressure above 180 or below 80, the bottle can provide alerts 941. This can be an alert to the user to go see a doctor immediately. In another example, a message is composed and then wirelessly sent to the user's healthcare provider. Data can be summarized and charted before sending. Blood pressure measurements can be plotted graphically or presented in diagrams. The data sent to the provider may include side effects of the medication(s). Using this data, the health care provider can adjust the medication(s) in a timely manner, which is typically faster than the usual patient report approach. Side effects can also be monitored and identified.

In another embodiment, the user may get visual reports 943, such as a blood pressure graph on a display on the bottle. The graph can show his blood pressure being in a downward trend, presumably attributed to his effort of taking the recommended dosage of medication. Such reports can serve as an encouragement, motivating the user to continue to be diligent in taking the medication. However, if the trend is unfavorable, the user might be more inclined to consult his healthcare provider. Such constant monitoring can minimize side effects.

In one embodiment, the amount of medication in the bottle is monitored. If the user is not taking the medication as recommended, or if the medication is not re-filled, the user's health care provider and/or a family member of the user could be alerted. This can promote compliance of taking medication and also can potentially identify the user for further counseling or health professional visit.

In one embodiment, a base, such as one described in FIG. 11, is for one type of health issues. For example, a base is dedicated to hypertension, and there can be three selected areas for three bottles, one for each type of medications as described above.

In one embodiment, the user has asthma. In this example, a bottle can include two metered dose inhalers, such as an Albuterol inhaler and a steroid inhaler, and the sensor includes a peak flow meter. FIG. 16C shows one process 950 the bottle goes through according to one embodiment. First, the bottle is individualized 952 based on the asthma condition of the user. Each user's peak flow number can be different. In one embodiment, the peak flow meter can be set into different zones, such as red, yellow and green zone. A health care professional can set the zone for the user based on the user's age, height and/or severity of asthma. In another embodiment, the bottle asks the user to enter his peak flow number. Every day, the peak flow meter takes readings 954 of the user. Then, the bottle asks 956 the user a number of questions regarding the user's symptoms. One question can be whether the user coughs or not. There can be a pull-down menu allowing the user to pick one of the three answers: often, occasionally and none. Another question can be whether the user wheezes or not. The bottle monitors 958 the user's responses. Based on the measurements and answers to the questions, the bottle can recommend inhaler and dosage 960. For example, one recommendation can be related to the dosage of one type of inhalers for the day, which can include the number and frequency of the metered dose inhaler. For example, when the user's peak flow reading is at the red zone, the recommendation can be that the user should take two puffs of the Albuterol inhaler every 15 minutes for three times, then every four hours and alert the user to call his health care professional. As another example, when the user's peak flow reading is in the green zone, the recommendation can be that the user needs to take regular dose of inhaled steroid. When the user needs to take the medication, the bottle can automatically remind 962 the user, such as how many puffs the user needs to take.

In one embodiment, the user has attention deficit hyperactivity disorder. The medication can include Ritalin, Concerta, Adderall and/or Straterra. FIG. 16D shows one process 975 a bottle goes through according to one embodiment. Each day, the bottle asks 977 a guardian of the user, such as one of the user's parents, a number of questions regarding the user. For example, one question can be the user's attention scale. Another question can be the % of work the user finished that day. A third question can be the user's hyperactivity scale that day being high, medium or low. A fourth question can be the user's appetite being normal, eating too much, or eating too little. A fifth question can be whether the user has other side effects, such as dizzy, unable to sleep and palpitation. A sixth question could be the user's weight. The bottle may send summarized data, which can be charted and graphed, to the user's health care provider, so dose adjustment 979 of the medication can be ordered if necessary. This can help identify side effects quickly. In one embodiment, the bottle also includes a built-in safety mechanism because the medication typically can be a controlled substance. For example, the weight of the bottle is monitored. If the amount of medication is decreasing at a rate beyond, or more than a preset percentage beyond, the recommended usage, the doctor of the user can be alerted 981 because there might be drug abuse.

Different embodiments for other prescription drugs are also applicable to the present invention, such as Propanolol for migraine headache, insulin for diabetes, lipid lowering drugs, or other drugs that need to be taken regularly, such as daily, or other drugs where the user needs to be frequently monitored of side effects.

Different approaches on measuring the quantity of substance consumed or left in a bottle have been described. In one embodiment, the usage of the substance is measured or is deduced based on sensing the number of times the bottle or the cap of the bottle has been opened. In another embodiment, the usage is measured based on sensing the empty space in the bottle, such as the distance or the volume between the bottle cap and the top level of the substance, such as the fluid, in the bottle. The cap covers an opening of the bottle to keep the substance in the bottle. This can be done, for example, by measuring the time it takes for an ultra-sonic pulse to travel from the cap to the top level of the fluid and back. Based on the travel time, the distance (and thus the volume of the substance left in the bottle) can be calculated. In yet another embodiment, the volume of the empty space is calculated based on measuring the acoustic resonance of the space to determine the size of the empty chamber.

Different types of inputs provided by the user have been described to provide user information. In one embodiment, another type of user inputs is for measuring the mental capacity of the user. For example, questions are presented to the user for answers. The questions can be mathematics questions. Alternatively, a pattern-matching game can be used to measure the user's mental capacity. In another embodiment, the prior health history of the user, which can be provided by the user, can include the health history of one or more family members of the user.

Different types of instruments have been described that can be coupled to a bottle. In one embodiment, an exercise machine, such as a bicycle, a treadmill, or a stepper machine, is electrically coupled to the bottle. The coupling could be direct between the bottle and the exercise machine, or indirect, such as through a base described above, where the machine is coupled to the base and the base is coupled to the bottle. In another embodiment, a scale for measuring the weight of the user is coupled to a bottle. Information from such a machine, like a scale, can be sent to the bottle. Such information can be used together with other information in the bottle to provide, for example, recommendation to the user.

Different types of sensors have been described to measure the user. In one embodiment, a bottle has additional information from one or more sensors measuring the environment in the immediate vicinity of the bottle. Examples of such sensors include one or more sensors for temperature, humidity, altitude, sunlight and/or ultra-violet radiation. In one embodiment, information regarding the environment can be used to dynamically determine whether the substance (e.g. medicine) in the bottle is still suitable for use by the user. The environment can also influence how often the substance is to be used by the user. In another embodiment, such information can be used together with other information in the bottle to provide, for example, recommendations for the user.

Different types of applications by a bottle have been described. In one embodiment, a bottle can provide personalized education and/or recommendation to the user regarding the substance the bottle contains. In one embodiment, the education and/or recommendation provided to the user is personalized to the user. For example, if the bottle carries antipyretic/analgesic medication, the appropriate amount recommended for a user can be tailored to the user based on the user's age, sex and weight. As another example, since many people with diabetes develop foot problem, though the bottle carries diabetes medication, the bottle provides education to the user regarding foot problems.

In another embodiment regarding applications, a bottle can recommend to a user regarding a health program the user is involved in. The bottle tracks the user's progress and compares the goals set by the user. Then, based on, for example, the user's consumption of the substance in the bottle, the user's weight and the user's activities, the bottle can determine if the program is effective, such as whether the user's weight-loss program is working.

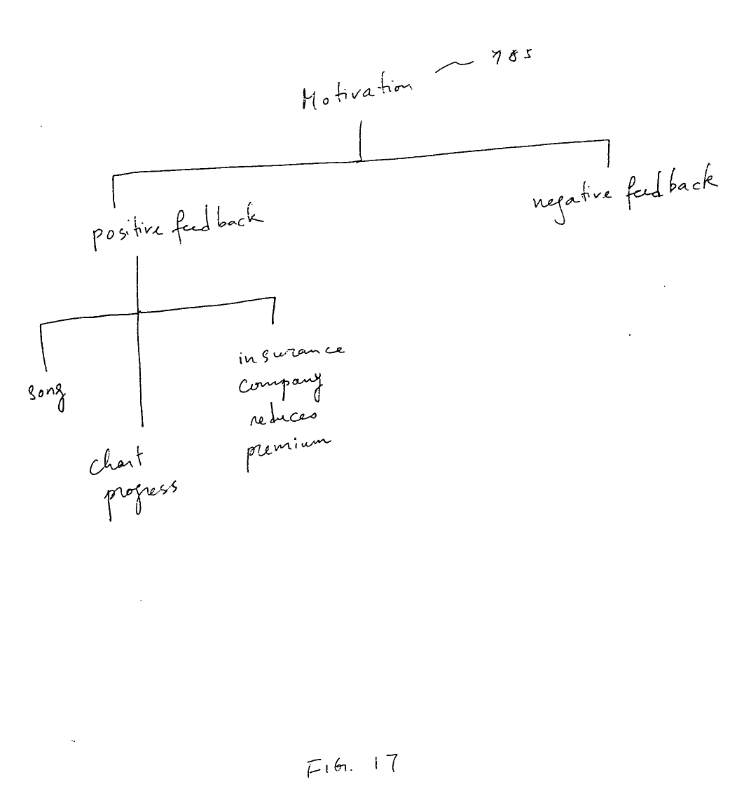

In one embodiment, a bottle can provide motivation to the user. FIG. 17 shows a number of examples 985 of such motivations. This can be particularly helpful for substances, such as medications, that have to be taken regularly, such as daily. It is not uncommon for users to forget or simply ignore taking the substances. In some situations, such lack of discipline can be dangerous, such as for medication to reduce high blood pressure. In one approach, the bottle can provide positive feedback to the user who has followed the recommended consumption or prescription. Such positive feedback can be a song the user likes. In another approach, the bottle can chart the user's progress. For example, the user has regularly followed the suggested guidelines by his health care provider and his blood pressure is going down. The bottle can visually provide such a chart to the user, showing the period that the user has followed the guidelines and the user's blood pressure during the same period. In yet another embodiment, the user's insurance company reduces the user's premium if the user has regularly followed the suggested guidelines. Instead of positive feedback, in one embodiment, a bottle can provide the user with negative feedback if the user has not been following the suggested guidelines. A negative feedback can be the opposite of a positive feedback just described. For example, instead of lowering the premium, the insurance company raises the premium if the user has not been following the guidelines.

In one embodiment, at least some of the functions previously described as performed by a bottle can be performed by another device. In another embodiment, a number of the functions previously described as performed by a bottle are performed by a computer coupled to a bottle, through, for example, a connector at the bottle. In a further embodiment, a number of functions previously described as performed by a bottle are performed by a remote website, wired or wirelessly coupled to a bottle. In yet another embodiment, a number of functions previously described as performed by a bottle are performed by a sensor electrically coupled to a bottle. Further, in one embodiment, at least some of the functions previously described as being performed by a bottle can be performed by a base, such as the base shown in FIG. 11. The base can be electrically coupled to the bottle.

Different embodiments have been described regarding a bottle carrying a substance. The substance can be in solid (such as pills), liquid or gaseous form, depending on the embodiment.

A number of embodiments have been described regarding a base coupled to a bottle. In one embodiment, a base can be used to measure the consumption of a substance in a container. One can scan the barcode on the container to download information regarding the substance into the base. The user can then weigh the container after the user consumes the substance, or can weigh before and after the consumption. This can allow the base to keep track of when and how much the user has consumed the substance.

A number of embodiments have been described based on a bottle. In one embodiment, instead of a bottle, different embodiments previously described are incorporated in a container, such as a box, a bag or a canister.

As described above, in one embodiment, a bottle has a connector to couple to electronics in the bottle. In an example, the connector is at the bottom of the bottle, such as in a recessed area. The electronics are also at the bottom of the bottle. To illustrate, there could be an electronics compartment at the bottom of the bottle to hold the electronics, which could be on a printed circuit board. The electronics compartment could be right below the bottom of the internal compartment of the bottle that holds a substance (e.g., pills). The connector can be further below or can be a part of the electronics component. Alternatively, a connector could include a pattern of conductive pads or dots on a surface, such as the bottom surface, of the printed circuit board. There could be stands at the bottom edge of the bottle to hold up the bottle, preventing the connector from touching the surface the bottle is standing on.

In yet another example, there could be an internal scale inside the bottle. For example, there is a compartment at the bottom of the bottle and the compartment holds a pressure sensor or a scale. The substance in the bottle can be on a plate (or in a cup, in a holder or in an inner container), and the plate (or other mechanisms) sits on the scale. The plate (or other mechanisms) is movable relative to the bottle housing. The scale can measure the weight of the substance on the plate (or other mechanisms) in the bottle. The scale keeps track of the weight of the substance, which in turn can provide an indication as to the quantity of substance left in the bottle. In another embodiment, a scale or a pressure sensor could be at the bottom of the bottle. The sensor measures the gravitational force or the weight of the bottle pressing against a solid surface where the bottle is sitting on. With the weight of the bottle being constant, a controller can automatically remove the bottle weight to determine the weight of the substance in the bottle.

In one embodiment, the electronics in the bottles include a memory device that keeps track of different types of information. Examples of the different types of information include the name of the user who should be taking the substance; the name of the substance in the bottle; the brand name of the bottle of substance; the name of the company manufacturing the substance; the name of the pharmacy distributing the bottle with the substance; the name of the doctor prescribing the substance; the time when the bottle with the substance was sold to the user or “filled” by a pharmacy; the price of the bottle with the substance; schedule indicating when and how the substance should be consumed; an expiration date of the substance in the bottle; any warnings regarding taking the substance; and conflicts the substance might have with other substances.

As described above, in one embodiment, based on the communication electronics in a bottle, the bottle can, via wire or wirelessly, connect to another computing device. In an example, the bottle is a first bottle, and the another computing device is a second bottle, both with communication electronics. Each bottle includes a memory device in its housing to electrically store a piece of information regarding the substance in that bottle and a piece of information regarding the user using the substance in the bottle, such as the user's name. Assume that the substance carried in the first bottle is different from the substance carried in the second bottle. In this example, the first bottle can transmit information to the second bottle to generate a message for the user regarding complications if the user consumes both the substances in the first and the second bottle.

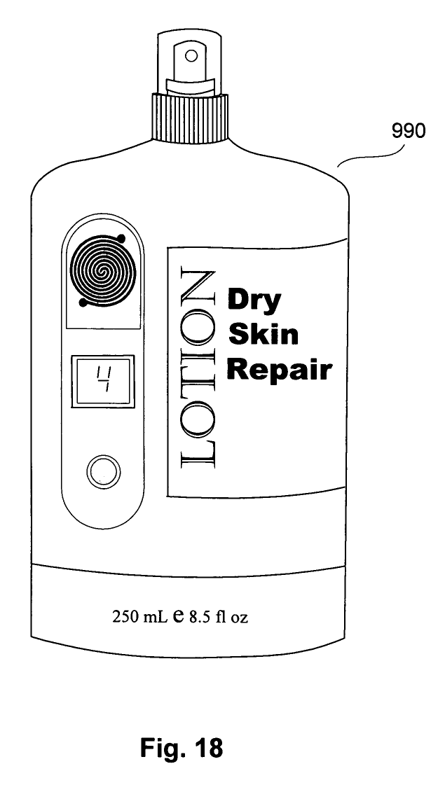

As described above, in one embodiment, a portable bottle includes a sensor that is coupled to the bottle housing. FIG. 18 shows an example 990 of such a bottle. The bottle housing includes an indented area where the sensor is located. A piece of material, such as a shrink wrap or a label, can be provided on the outside of the bottle housing. The piece of material can be configured to mechanically hold the sensor in the indented area. There could be a logo or other advertising materials on the piece of materials, or on the outside of the bottle. In one embodiment, the piece of material could include an opening exposing at least a portion of the sensor head to allow the sensor head not to be covered by the piece of material. Some sensor heads need to have direct contact with the area to be measured. Covering the sensor head could distort the measurements. The piece of material can include a window showing a display output for the sensor. In this example, the display output shows the numeral 4. The piece of material could include another opening exposing an on/off switch for the sensor. In this example, the on/off switch is a dome-shaped button.

As described above, in a number of embodiments, a portable bottle can have a speaker and a memory device. The bottle can be configured to carry a consumable substance or a substance for a user to consume. For example, the substance is a substance or product for the user to eat or drink, such as a type of food or medication. In another example, the substance is a substance or a product for the user to use or own. In any event, the user can consume the substance by accessing the substance from the bottle.

In one embodiment, the memory device can be configured to carry information to generate a message for the speaker to output. In one embodiment, the information can be related to the consumable substance in the bottle, such as a piece of information regarding the medication in the bottle. In another embodiment, the information can be specific to the user of the bottle, such as the name of the user. In yet another embodiment, the information can be both related to the substance and specific to the user, such as prescription information for the user regarding the medication carried in the bottle.

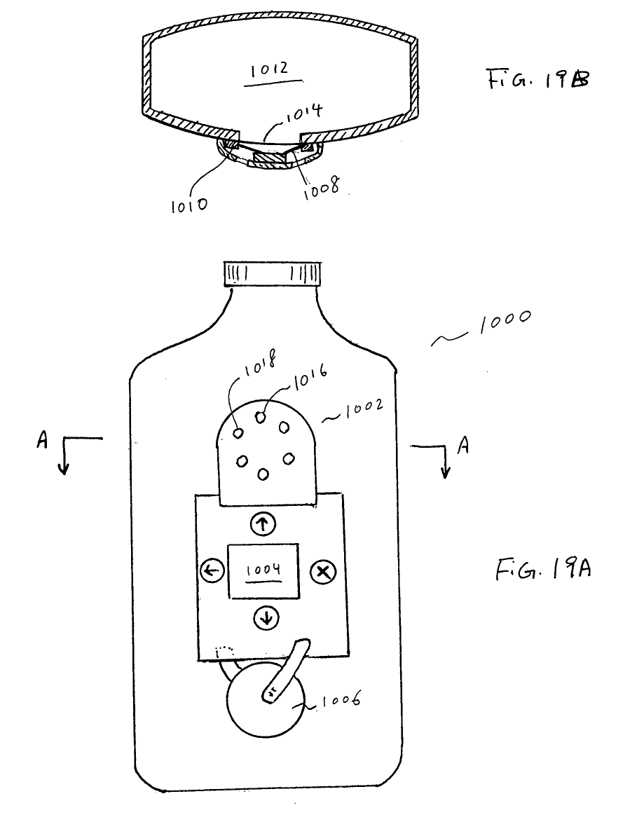

FIGS. 19A-B show an embodiment of a portable bottle 1000 with a speaker 1002, a display 1004, a battery 1006 and other electrical components, such as a memory device. The speaker 1002 can be a type of speaker that directly moves a compressible material to generate sound. In one embodiment, a compressible material is a type of material that can be compressed and relaxed by sound waves. Examples of compressible materials include air, foam such as shaving cream, pre-wiped wipe cream, marshmallow, popped popcorn, and solid objects in air (such as pills in bottles).

In one embodiment, the speaker 1002 is based on magnetic forces applied to a current-carrying coil. The speaker is attached to at least a portion of the bottle housing. In one approach, the area in the interior of the bottle that is adjacent to the speaker includes a compressible material. For example, initially the bottle is filled with incompressible materials. As a user consumes the incompressible materials, air goes into the bottle to replace the consumed portion. Gradually, the area in the interior of the bottle that is adjacent to the speaker will include air, a compressible material. Typically, for this type of speaker, electrical signals in an alternating current are sent through the coil, which is in a magnetic field, to control the vibration of a speaker diaphragm 1008, which, in turn, generates sound waves in the compressible material.

In one embodiment, the edges of the diaphragm 1008 are attached to a frame 1010. The position of the frame 1010 is fixed relative to the bottle 1000. This allows the speaker to be attached to a portion of the bottle. In one embodiment, the frame 1010 could be a part of the wall of the bottle housing. The diaphragm 1008 has two surfaces. One surface faces the interior 1012 of the bottle housing. Then as the diaphragm 1008 vibrates to generate sound waves in the compressible material, at least a portion of the sound waves from the surface facing the interior moves towards and is captured by the interior 1012 of the bottle housing. The other surface of the diaphragm 1008 faces away from the interior 1012 of the bottle housing. That surface can be in direct contact to air in the outside environment of the bottle housing through a number of holes, 1016 and 1018. Then, as the diaphragm 1008 vibrates to generate sound waves, at least a portion of the sound waves from the surface facing the outside environment moves towards the outside environment of the bottle housing. These sound waves can be heard by a user of the bottle.

In the embodiment shown in FIG. 19B, there is a membrane 1014 or a layer of material between the interior 1012 of the bottle (or the substance in the bottle) and the diaphragm 1008 of the speaker 1002. The membrane 1014 is relatively thin. As the diaphragm 1008 vibrates to generate sound waves towards the interior 1012 of the bottle, the membrane follows the vibration, in phase.

Instead of having a membrane between the diaphragm and the interior of the bottle, in one embodiment, the speaker 1002 is attached over a portion of the wall of the bottle, and the wall of the bottle (or at least the portion of the wall of the bottle where the speaker is attached) is relatively thin. As the speaker vibrates to generate sound waves, at least the portion of the bottle wall where the speaker is attached also vibrates.

In both embodiments, as the membrane or as at least a portion of the bottle wall vibrate, the vibration can be translated at least to the compressible material in the interior of the bottle adjacent to the speaker. In one embodiment, the maximum amplitude of the vibration of the membrane and/or the wall is typically a fraction of the maximum amplitude of the vibration of the speaker diaphragm. In one approach, the fraction is more than 50%, and in another approach, the fraction is more than 25%. For example, the wall of the bottle is plastic, and the thickness of the portion of the wall where the speaker is attached is less than 10 mils thick. In one example, the plastic wall has the thickness of about 0.5 mils.

Instead of having a membrane or a thin wall, one embodiment removes at least a portion of the wall of the bottle housing where the speaker 1002 is attached. This allows the diaphragm 1008 to be in direct contact with the compressible material in the bottle at least in the area adjacent to the speaker, without a membrane 1014 or the wall of the bottle in between.

In FIGS. 19A-B, the speaker is attached to the wall of the bottle. In another embodiment, a bottle has a cap and a speaker is attached to the cap. For example, the cap is made of plastic, and a speaker is attached to the cap in ways similar to the speaker being attached to the wall of the bottle as described in this application. In one embodiment, the cap can be considered as a part of the housing of the bottle.

In one embodiment, the volume and/or the pitch of the sound waves that can be heard by a user of the bottle is referred to as the quality of the sound waves. With the speaker attached to a portion of the bottle, the quality of the sound waves is improved.

In another embodiment, the speaker is directly attached to the bottle, and the speaker moves at least a portion of the wall of the bottle to generate sound. To illustrate, the speaker is a piezoelectric speaker, which can have a piece of piezoelectric element with one side attached to a metal diaphragm. The other side of the piece of piezoelectric element can be coated with an electrically conductive material. This conductive material can be, for example, vapor-deposited, electro-less plated or painted-on using a conductive paint, like a silver paint. The speaker has two surfaces, one being the outside surface of the metal diaphragm, and the other being the outside surface of the conductive coating.

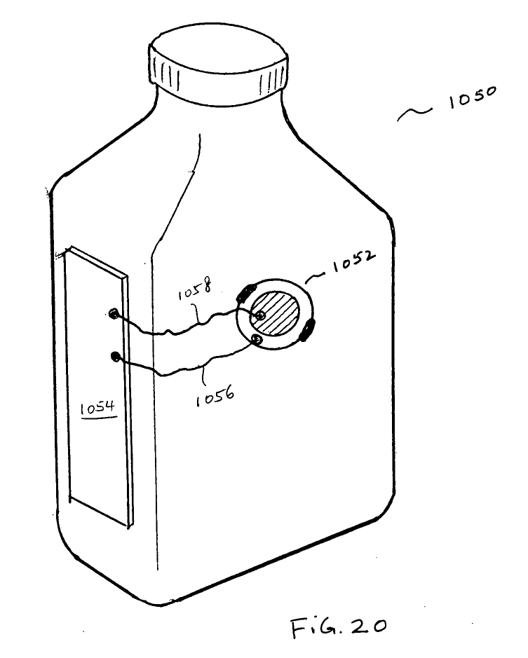

FIG. 20 shows an embodiment of a piezoelectric speaker 1052 attached to a portion of a bottle 1050. In one embodiment, the area adjacent to the speaker in the interior of the bottle includes a compressible material. In the figure, the speaker is located approximately at the middle of the bottle. In another embodiment, the speaker can be located higher up, such as close to the cap of the bottle. The figure also shows the speaker 1052 being controlled by electrical components on a circuit board 1054 via conductive elements, 1056 and 1058. As shown in the figure, with the speaker 1052 attached to a portion of the bottle 1050, one surface of the piezoelectric speaker 1052 faces the bottle housing. Then, as the piezoelectric speaker 1052 vibrates to generate sound waves, at least a portion of the sound waves from the surface facing the bottle housing moves towards and is captured by the interior of the bottle housing.

As explained, in this embodiment, at least a portion of the wall where the piezoelectric speaker is attached vibrates. To enhance the quality of the sound wave, the wall material is more flexible than the piezoelectric materials. In one embodiment, the force constant of the piezoelectric materials is more than the force constant of the wall materials. In other words, with the same amount of mechanical force bending both materials, the wall material flexes more than the piezoelectric material. In one example, the force constant of the piezoelectric material is at least twice the force constant of the wall material. In another example, the force constant of the piezoelectric material is at least four times that of the wall material.

In FIG. 20, a speaker 1052 is shown to be attached to the outside of the bottle 1050. In another embodiment, a speaker can be attached to the inside of the bottle 1050. As the speaker vibrates, the wall of the bottle at least in the vicinity of the position where the speaker is attached also vibrates to generate sound waves for a user to hear.

In one embodiment, the surface of the piezoelectric speaker attached to the bottle housing is substantially flat. In another embodiment, the surface of the speaker attached to the bottle is curved in a concave manner. The bottle surface can also be curved and the curvature of the speaker can be substantially conformed to the curvature of the portion of the bottle where the speaker is attached. With such a curve surface, the sound waves generated towards the bottle are more focused towards the interior of the bottle. One way to generate a piezoelectric speaker with a curved surface is to make the speaker with a piezoelectric thermo-plastic, such as KYNAR.

In another embodiment, both surfaces of the piezoelectric speaker 1052 are curved, with one being concave and the other convex. The concave surface can be the surface facing the bottle. The convex surface can be the surface where at least a substantial amount of the sound waves generated propagate away from the bottle. Such a convex surface generates a more diverging beam of sound waves.

The bottle could be carrying different types of consumable substances. Depending on the type of substances carried and the amount left in the bottle, the pitch and/or the volume of the sound waves can vary.

In one embodiment, the pitch and/or the volume of the sound waves are calibrated for the consumable substance in the bottle. For example, the power driving the speaker is fixed. Then the volume and/or the pitch of the sound waves with the bottle capped is measured at different amount of the substance in the bottle. For example, measurements can be made with the bottle empty, ¼ full, ½ full and ¾ full of the substance. After the calibration, based on measuring the volume and/or the pitch, the amount of substance left in the bottle can be estimated. Thus, through calibration, the pitch and/or the volume of the sound waves can provide indications to the type and/or the amount of the substance left in the bottle.

Another way to determine the type and/or the amount of the substance left in the bottle is by driving the speaker till the speaker oscillates. The resonant frequency depends on the type and/or the amount of the substance left in the bottle. For example, the speaker can be a type of speaker that directly moves a compressible material to generate sound. One can drive the speaker with a constant voltage but at different frequencies. At or around the resonant frequency, the amount of current required to drive the speaker can be lower than the amount of current required when the speaker is driven not at the resonant frequency. Based on measuring the current, the resonant frequency can be identified. The bottle can previously been calibrated, for example, by charting the change in resonant frequency as a function of the amount of substance left in the bottle. Then based on the resonant frequency identified, the amount of substance left in the bottle can be determined.

As another example, the speaker can be a piezoelectric speaker with three connectors, two being the normal ones driving the vibration of the piezoelectric speaker, and the third for sensing the piezoelectric speaker. In this example, a wire from the third connector is connected to the input of the amplifier driving the speaker. With this configuration, the piezoelectric speaker would oscillate at its resonant frequency. One way to measure the resonant frequency is to measure the frequency of the voltage peaks as the piezoelectric speaker oscillates. Based on the resonant frequency, one can again determine the type and/or the amount of the substance left in the bottle.

In another embodiment, the quality of the sound waves or the oscillating frequencies can provide indication as to the state or status of the substance in the bottle. For example, the bottle carries ice cubes. Depending on whether the ice cubes have melted, the quality of the sound waves differs. Based on the quality of the sound waves measured, one can tell the state of the ice cubes.

A number of embodiments have been described regarding a speaker being attached to a portion of a portable bottle. In one embodiment, there could be more than one speaker attached to a portable bottle. In another embodiment, the multiple speakers can be different types of speakers. For example, two different types of speakers are attached to a bottle, one being a piezoelectric speaker and the other being a speaker based on magnetic forces applied to current-carrying wires. The piezoelectric speaker can be more applicable to higher audio frequencies, such as those above 1000 Hz, while the speaker using magnetic forces can be more applicable to lower audio frequencies, such as those below 1000 Hz.

In another embodiment, a portable bottle also includes a memory device that is configured to carry information related to the consumable substance in the bottle, or specific to the user of the bottle. A speaker attached to the bottle housing can output a message based on the information under a predetermined condition. For example, the bottle carries medication, and a message based on the information can be both related to the substance and specific to the user, such as calling the name of the user to remind him to take the medication.

The message can be generated under a predetermined condition. For example, the message is generated when the time comes for the user to take the medication. The same message could be generated by the speaker every few minutes for a number of times, and then stop. Examples of other types of messages previously described above in this application could also be generated.

A number of embodiments have been described regarding a speaker being attached to a portion of a bottle. More generally, instead of a bottle, a speaker can be attached to a portion of a portable container. Examples of a portable container include a cardboard box, a bag and a plastic cylindrical canister. Such a container can be configured to carry a consumable substance, and can also be configured to include a mechanism to allow a user to access the substance for consumption.

As described above, one type of speaker is a type that can be in direct contact with a compressible material in the container. For such embodiments, the container has a substantially rigid structure. Examples of such type of structure are a box or a bottle. The box can be the type that can be flexibly collapsible into connected flat sheets and returned to its three-dimensional shape as desired.

Another type of speaker is a type that can directly attach to the wall of the container and flex the wall to generate sound. For such embodiments, the container does not need to have a substantially rigid structure. The container can be a bag with a compressible material inside, at least in the region adjacent to the speaker.

There are different ways to allow the user to access the substance in the container to consume it. For example, one mechanism allows generating an opening at the container by removing a structure from the container, such as a lid or a cap. Another example allows generating an opening at the container without removing a structure from the container. For example, one can generate a spout at the container by changing or twisting a portion of the structure of the container, as in some milk cartons. The user can access the substance to consume through the opening generated. In another example, the container has an opening through which the substance can be accessed for consumption. To illustrate, there could be a straw attached to the container and the user can access the substance through the straw.

In one embodiment, the container also includes a memory device that is configured to carry information related to the substance and/or specific to the user of the container. To illustrate, the substance is a type of cereal, and the container is a cereal box, whose brand can be associated with a tiger. The message could be the roaring sound of a tiger. As another example, the substance is tennis balls, and the container is a plastic canister. The message can be the sound of a tennis ball in high speed when it is served by a professional tennis player. As yet another embodiment, a speaker is attached to a plastic, leather or vinyl purse, such as using one of the techniques described in this application. The message can be the name of the user of the purse.

In another embodiment, under certain predetermined condition(s), one or more messages would be generated by a speaker attached to a portion of a container. In one embodiment, the condition is manual. For example, the manual condition depends on a user activating a mechanical switch. To illustrate, a cereal box has a button. When the button is pressed, the speaker would generate the roaring sound of a tiger. As another example, the container has a cap. When the cap is removed, a switch is activated to generate a message. In another embodiment, the condition is automatic, based on, for example, time. To illustrate, at a certain time, a message would be generated. As another example, the automatic condition is based on position, such as the container generating a message when the container is around a certain location, as determined, for example, through a position-sensing device.

The various embodiments, implementations and features of the invention noted above can be combined in various ways or used separately. Those skilled in the art will understand from the description that the invention can be equally applied to or used in other various different settings with respect to various combinations, embodiments, implementations or features provided in the description herein.

A number of embodiments in the invention can be implemented in software, hardware or a combination of hardware and software. A number of embodiments of the invention can also be embodied as computer readable code on a computer readable medium. The computer readable medium is any data storage device that can store data which can thereafter be read by a computer system. Examples of the computer readable medium include read-only memory, random-access memory, CD-ROMs, magnetic tape, optical data storage devices, and carrier waves. The computer readable medium can also be distributed over network-coupled computer systems so that the computer readable code is stored and executed in a distributed fashion.

Numerous specific details are set forth in order to provide a thorough understanding of the present invention. However, it will become obvious to those skilled in the art that the invention may be practiced without these specific details. The description and representation herein are the common meanings used by those experienced or skilled in the art to most effectively convey the substance of their work to others skilled in the art. In other instances, well-known methods, procedures, components, and circuitry have not been described in detail to avoid unnecessarily obscuring aspects of the present invention.

Also, in this specification, reference to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

1. A portable container for a user comprising:
a container housing configured to carry a consumable substance, which the user can consume by accessing the substance from the container;
a memory device configured to store information that is related to the substance, or that is specific to the user; and
a speaker attached to a portion of the housing, with the speaker outputting a message based on the information under a predetermined condition,
wherein the area in the interior of the container that is adjacent to the speaker includes a compressible material,
wherein the speaker has a first surface and a second surface, and
wherein one surface of the speaker is directed at the interior of the container housing so that as the speaker vibrates to generate sound waves, at least a portion of the sound waves from that surface of the speaker are directed towards the interior of the container housing, which improves the quality of the sound waves generated by the speaker and received by the user.

2. A portable container as recited in claim 1,
wherein the speaker is based on magnetic forces applied to a current-carrying coil,
wherein the coil is connected to a diaphragm, whose vibrations generate the sound waves, and
wherein the diaphragm includes two surfaces, with one surface facing the interior of the container housing.

3. A portable container as recited in claim 2,
wherein there is a membrane between the interior of the housing and the diaphragm, and
wherein as the diaphragm vibrates to generate sound waves towards the interior of the housing, the membrane follows the vibration in phase.

4. A portable container as recited in claim 2, wherein the diaphragm is in direct contact with the substance in the container.

5. A portable container as recited in claim 1, wherein the quality is related to the volume or the pitch of the sound waves.

6. A portable container as recited in claim 1, wherein the amount or the state of the substance in the container is electronically determined.

7. A portable container as recited in claim 6, wherein the amount of the substance is determined by determining the weight of the substance.

8. A portable container as recited in claim 6, wherein the amount of the substance is determined based on the quality of the sound waves or a resonant frequency.

9. A portable container as recited in claim 1, wherein the speaker includes a piezoelectric element.

10. A portable container as recited in claim 9, wherein the speaker is curved.

11. A portable container as recited in claim 1, wherein more than one speaker is attached to the container.

12. A portable container as recited in claim 1, wherein the predetermined condition is either a manual or an automatic condition.

13. A portable container as recited in claim 1,
wherein the container is coupled to a sensor, which is configured to measure an attribute of the user or the environment that the user is in, and
wherein the substance is related to the attribute.

14. A container as recited in claim 13,
wherein the sensor is electrically coupled to the container housing, and
wherein the speaker is configured to output information regarding the measured attribute of the user.

15. A container as recited in claim 13 wherein the memory device is also configured to store information that is related to the health or a preference of the user.

16. A container as recited in claim 13 wherein the container keeps track of the measurements of the sensor and the time when the measurements are made.

17. A container as recited in claim 1 wherein the container includes a mechanism that allows the user to enter an input to be electrically stored in the container.

18. A container as recited in claim 1 wherein the container includes an electrical mechanism configured to facilitate data exchange between the container and an external electrical apparatus.

19. A container as recited in claim 1,
wherein the substance is a type of medication, and
wherein the message is related to side effects, precautions, drug interactions, and/or health news related to the substance.

20. A container as recited in claim 1,
wherein the substance is for the user to eat or drink, and
wherein the container provides an indication to the user regarding when the user should consume at least a portion of the substance.

21. A container as recited in claim 1 wherein the container electronically promotes a product or a service to the user.

22. A container as recited in claim 1 wherein the container keeps track of its own location.
